(19) United States
(12) Patent Application Publication
(10) Pub. No.: US 2014/0237273 A1
(43) Pub. Date: Aug. 21, 2014

(54) INFORMATION PROCESSING APPARATUS, INFORMATION PROCESSING METHOD, AND PROGRAM

(71) Applicant: Sony Corporation, Minato-ku (JP)

(72) Inventors: Keiichi HIRANO, Tokyo (JP); Satoru IWASAKI, Tokyo (JP); Tomohiro KATORI, Tokyo (JP); Ryo TAKAHASHI, Saitama (JP)

(73) Assignee: Sony Corporation, Minato-ku (JP)

(21) Appl. No.: 14/143,674

(22) Filed: Dec. 30, 2013

(30) Foreign Application Priority Data
Feb. 15, 2013 (JP) 2013-028009

(51) Int. Cl. G06F 1/32

(52) U.S. Cl. CPC G06F 1/32
USPC 713/320

(57) ABSTRACT

An information processing apparatus includes: a wakeup-target identifying section configured to identify a wakeup target in response to a wakeup trigger; and a wakeup processing section configured to wake up the wakeup target identified by the wakeup-target identifying section.

### CROSS REFERENCE TO RELATED APPLICATIONS

This application claims the benefit of Japanese Priority Patent Application JP 2013-028009 filed Feb. 15, 2013, the entire contents of which are incorporated herein by reference.

### BACKGROUND

The present technology relates to information processing apparatuses, information processing methods, and programs, and particularly relates to an information processing apparatus, an information processing method, and a program which are capable of further reducing the time taken for wakeup processing.

Heretofore, in resume processing (wakeup processing) in an information processing apparatus, a technique has been proposed for reducing the time taken for the resume processing by omitting initialization process(es) of one or more device drivers (see, e.g., Japanese Unexamined Patent Application Publication No. 2010-157017).

### SUMMARY

However, in the technique disclosed in Japanese Unexamined Patent Application Publication No. 2010-157017, the initialization process(es) to be omitted are the same regardless of the type of wakeup trigger, and an unwanted initialization process may be performed depending on a wakeup trigger. Accordingly, it is desired to further reduce the time taken for the wakeup processing by waking up only a wakeup target that is optimum for the wakeup trigger.

The present technology has been made in view of such a situation and is intended to make it possible to further reduce the time taken for the wakeup processing.

According to one embodiment of the present technology, there is provided an. The information processing apparatus includes: a wakeup-target identifying section configured to identify a wakeup target in response to a wakeup trigger; and a wakeup processing section configured to wake up the wakeup target identified by the wakeup-target identifying section.

An information processing method and a program according to another embodiment of the present technology correspond to the information processing apparatus according to the embodiment of the present technology.

According to the embodiments of the present technology, a wakeup target is identified in response to a wakeup trigger, and the identified wakeup target is woken up.

According to the embodiments of the present technology, it is possible to further reduce the time taken for the wakeup processing.

### BRIEF DESCRIPTION OF THE DRAWINGS

FIG. 1 is a block diagram illustrating the concept of a wakeup processing section according to an embodiment of the present technology;

FIG. 2 is a flowchart illustrating wakeup processing performed by the wakeup processing section illustrated in FIG. 1;

FIG. 3 is a block diagram illustrating an example configuration of a recording playback apparatus according to a first embodiment of an information processing apparatus to which the present technology is applied;

FIG. 4 is a block diagram illustrating an example configuration of a wakeup processing section implemented by the recording playback apparatus illustrated in FIG. 3;

FIG. 5 illustrates an example of the wakeup table illustrated in FIG. 4;

FIG. 6 is a flowchart illustrating wakeup processing performed by the wakeup processing section illustrating FIG. 4;

FIG. 7 is a block diagram illustrating an example configuration of a mobile phone according to a second embodiment of the information processing apparatus to which the present technology is applied;

FIG. 8 is a block diagram illustrating an example configuration of a wakeup processing section implemented by the mobile phone illustrated in FIG. 7;

FIG. 9 illustrates an example of the wakeup table illustrated in FIG. 8;

FIG. 10 is a block diagram illustrating an example configuration of a digital camera according to a third embodiment of the information processing apparatus to which the present technology is applied;

FIG. 11 is a block diagram illustrating an example configuration of a wakeup processing section implemented by the digital camera illustrated in FIG. 10;

FIG. 12 illustrates an example of the wakeup table illustrated in FIG. 11;

FIG. 13 is a block diagram illustrating an example configuration of portable audio equipment according to a fourth embodiment of the information processing apparatus to which the present technology is applied;

FIG. 14 is a block diagram illustrating an example configuration of a wakeup processing section implemented by the portable audio equipment illustrated in FIG. 13;

FIG. 15 illustrates an example of the wakeup table illustrated in FIG. 14;

FIG. 16 is a block diagram illustrating an example configuration of an IC recorder according to a fifth embodiment of the information processing apparatus to which the present technology is applied;

FIG. 17 is a block diagram illustrating an example configuration of a wakeup processing section implemented by the IC recorder illustrated in FIG. 16;

FIG. 18 illustrates an example of the wakeup table illustrated in FIG. 17;

FIG. 19 is a block diagram illustrating an example configuration of a video camera according to a sixth embodiment of the information processing apparatus to which the present technology is applied;

FIG. 20 is a block diagram illustrating an example configuration of a wakeup processing section implemented by the video camera illustrated in FIG. 19;

FIG. 21 illustrates an example of the wakeup table illustrated in FIG. 20;

FIG. 22 is a block diagram illustrating an example configuration of a television set according to a seventh embodiment of the information processing apparatus to which the present technology is applied;

FIG. 23 is a block diagram illustrating an example configuration of a wakeup processing section implemented by the television set illustrated in FIG. 22;

FIG. 24 illustrates an example of the wakeup table illustrated in FIG. 23;

FIG. 25 is a block diagram illustrating an example configuration of an additional wakeup processing section implemented by the mobile phone illustrated in FIG. 7; and

FIG. 26 illustrates an example of the additional wakeup table illustrated in FIG. 25.

### DETAILED DESCRIPTION OF EMBODIMENTS

### <Concept of Present Technology>

### (Concept of Wakeup Processing Section)

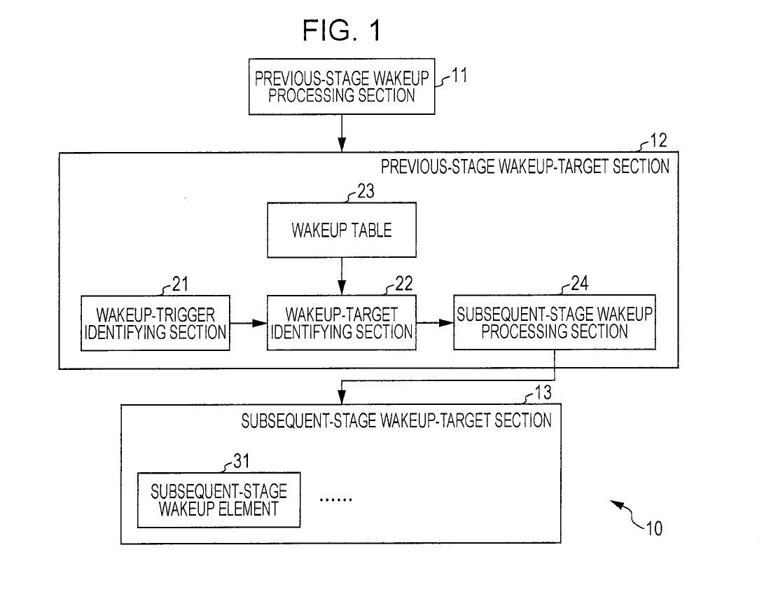

FIG. 1 is a block diagram illustrating the concept of a wakeup processing section according to an embodiment of the present technology.

As illustrated in FIG. 1, a wakeup processing section 10 according to the present technology includes a previous-stage wakeup processing section 11, a previous-stage wakeup-target section 12, and a subsequent-stage wakeup-target section 13. The wakeup processing section 10 identifies a wakeup trigger and wakes up a wakeup target corresponding to the identified wakeup trigger.

More specifically, when a wakeup trigger occurs, the previous-stage wakeup processing section 11 in the wakeup processing section 10 wakes up the previous-stage wakeup-target section 12, regardless of the type of wakeup trigger.

The previous-stage wakeup-target section 12 includes a wakeup-trigger identifying section 21, a wakeup-target identifying section 22, a wakeup table 23, and a subsequent-stage wakeup processing section 24.

The wakeup-trigger identifying section 21 identifies a wakeup trigger that has occurred and supplies information indicating the identified wakeup trigger to the wakeup-target identifying section 22.

The subsequent-stage wakeup-target section 13 includes one or more (typically, a plurality of) subsequent-stage wakeup elements 31. By referring to the wakeup table 23, the wakeup-target identifying section 22 identifies, as a wakeup target, at least one of the subsequent-stage wakeup elements 31 which corresponds to the wakeup trigger indicated by the information supplied from the wakeup-trigger identifying section 21 and which is to be woken up after the previous-stage wakeup-target section 12. The wakeup-target identifying section 22 supplies information indicating the identified subsequent-stage wakeup element(s) 31 to the subsequent-stage wakeup processing section 24.

The wakeup table 23 is a table in which wakeup triggers and the subsequent-stage wakeup elements 31 to be woken up during wakeup due to the corresponding wakeup triggers are associated with each other. The subsequent-stage wakeup processing section 24 wakes up, in the subsequent-stage wakeup-target section 13, the subsequent-stage wakeup element(s) 31 indicated by the information supplied from the wakeup-target identifying section 22.

The subsequent-stage wakeup element(s) 31 included in the subsequent-stage wakeup-target section 13 are devices (which may include drivers) or processes.

### (Description of Processing Performed by Wakeup Processing Section)

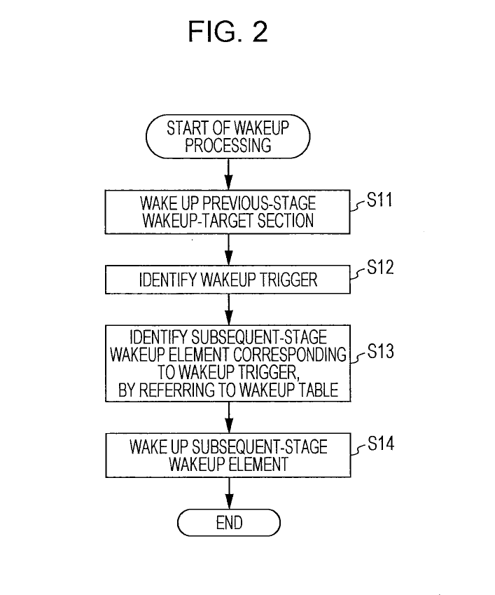

FIG. 2 is a flowchart illustrating wakeup processing performed by the wakeup processing section 10 illustrated in FIG. 1. This wakeup processing is initiated when a wakeup trigger occurs.

In step S11 in FIG. 2, the previous-stage wakeup processing section 11 in the wakeup processing section 10 wakes up the previous-stage wakeup-target section 12. As a result, the state transitions to a state in which a wakeup trigger can be identified, a wakeup target can be identified by referring to the wakeup table 23, and a wakeup target can be woken up.

In step S12, the wakeup-trigger identifying section 21 in the previous-stage wakeup-target section 12 identifies a wakeup trigger and supplies information indicating the identified wakeup trigger to the wakeup-target identifying section 22.

In step S13, by referring to the wakeup table 23, the wakeup-target identifying section 22 identifies, as a wakeup target, the subsequent-stage wakeup element 31 corresponding to the wakeup trigger indicated by the information supplied from the wakeup-trigger identifying section 21. The wakeup-target identifying section 22 then supplies information indicating the identified subsequent-stage wakeup element 31 to the subsequent-stage wakeup processing section 24.

In step S14, the subsequent-stage wakeup processing section 24 wakes up, in the subsequent-stage wakeup-target section 13, the subsequent-stage wakeup element 31 indicated by the information supplied from the wakeup-target identifying section 22. As a result, the state transitions to a state in which an operation corresponding to the wakeup trigger can be executed.

### First Embodiment

### Example Configuration of First Embodiment of Information Processing Apparatus

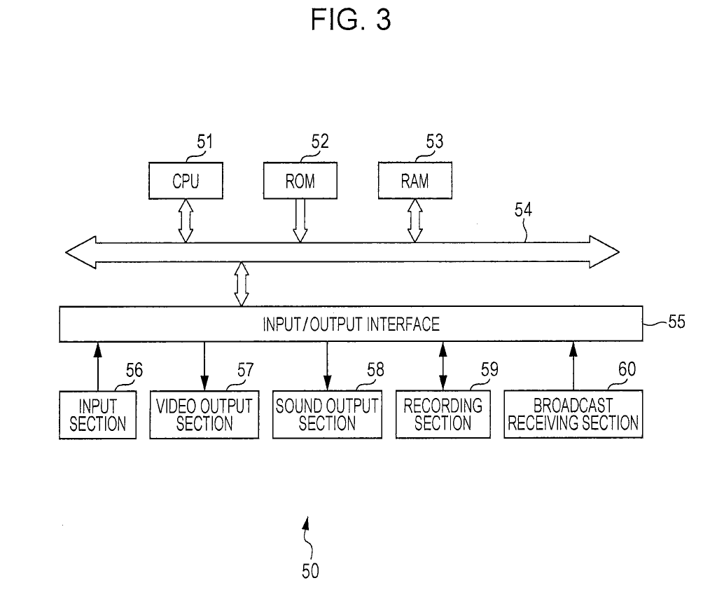

FIG. 3 is a block diagram illustrating an example configuration of a recording playback apparatus according to a first embodiment of an information processing apparatus to which the present technology is applied.

A recording playback apparatus 50 illustrated in FIG. 3 is a hard disk recorder or the like and performs scheduled recording of a broadcast program, playback of a recorded broadcast program, and so on.

In the recording playback apparatus 50, a central processing unit (CPU) 51, a read only memory (ROM) 52, and a random access memory (RAM) 53 are coupled to each other through a bus 54. An input/output interface 55 is further coupled to the bus 54. An input section 56, a video output section 57, a sound output section 58, a recording section 59, and a broadcast receiving section 60 are coupled to the input/output interface 55.

For example, the CPU 51 performs scheduled recording of a broadcast program, playback of a recorded broadcast program, and so on, for example, by loading a program recorded in the recording section 59 into the RAM 53 through the input/output interface 55 and the bus 54 and executing the loaded program. During the processing, the CPU 51 refers to information stored in the ROM 52 or writes/reads information to/from the RAM 53, as appropriate.

The input section 56 includes various operation buttons, such as a playback button. The playback button is a button that a user operates to play back a broadcast program recorded (video and sound recorded) in the recording section 59.

During playback of a recorded broadcast program, under the control of the CPU 51, the video output section 57 outputs video of a broadcast program, recorded in the recording section 59, on an external display (not illustrated), or the like. During playback of a recorded broadcast program, under the control of the CPU 51, the sound output section 58 outputs sound of a broadcast program, recorded in the recording section 59, to an external speaker (not illustrated), or the like.

The recording section 59 includes a hard disk, a nonvolatile memory, and so on. During scheduled recording of a broadcast program, under the control of the CPU 51 or the like, the recording section 59 records video, sound, and so on of a broadcast program received by the broadcast receiving section 60. During playback of a recorded broadcast program, under the control of the CPU 51 or the like according to an operation or the like of the playback button, the recording section 59 reads video of a recorded broadcast program and supplies the video to the video output section 57, and reads sound of the recorded broadcast program and supplies the sound to the sound output section 58.

The broadcast receiving section 60 includes a tuner and so on. During scheduled recording of a broadcast program, under the control of the CPU 51 or the like, the broadcast receiving section 60 receives a program broadcast on a predetermined channel at a predetermined time and supplies video and sound of the broadcast program to the recording section 59.

The recording playback apparatus 50 configured as described above implements the wakeup processing section 10 illustrated in FIG. 1. A wakeup processing section implemented by the recording playback apparatus 50 will be described below.

### (Example Configuration of Wakeup Processing Section)

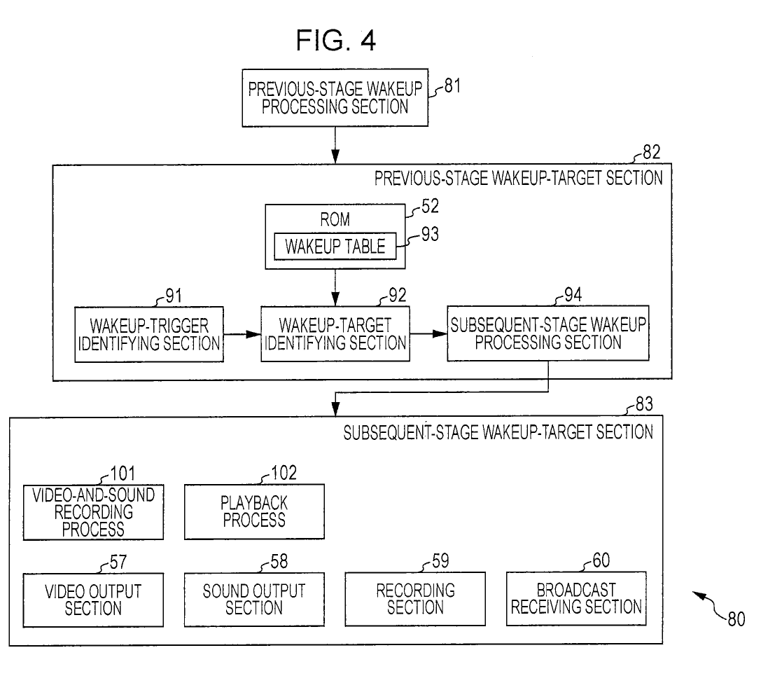

FIG. 4 is a block diagram illustrating an example configuration of a wakeup processing section implemented by the recording playback apparatus 50 illustrated in FIG. 3.

As illustrated in FIG. 4, a wakeup processing section 80 implemented by the recording playback apparatus 50 includes a previous-stage wakeup processing section 81, a previous-stage wakeup-target section 82, and a subsequent-stage wakeup-target section 83.

The previous-stage wakeup processing section 81 implements the previous-stage wakeup processing section 11 illustrated in FIG. 1, for example, through use of the CPU 51 illustrated in FIG. 3. That is, when a wakeup trigger occurs and the state transitions from a sleep state, such as a suspension or hibernation state, to an operating state, the previous-stage wakeup processing section 81 wakes up the previous-stage wakeup-target section 82.

The previous-stage wakeup-target section 82 implements the previous-stage wakeup-target section 12 illustrated in FIG. 1. That is, the previous-stage wakeup-target section 82 includes a wakeup-trigger identifying section 91, a wakeup-target identifying section 92, a wakeup table 93 stored in the ROM 52, and a subsequent-stage wakeup processing section 94. The wakeup-trigger identifying section 91 identifies a wakeup trigger that occurs in the sleep state, the wakeup-target identifying section 92 refers to the wakeup table 93 to identify, as a wakeup target, the subsequent-stage wakeup element corresponding to the identified wakeup trigger, and the subsequent-stage wakeup processing section 94 wakes up the identified subsequent-stage wakeup element.

The wakeup-trigger identifying section 91, the wakeup-target identifying section 92, and the subsequent-stage wakeup processing section 94 are implemented by, for example, the CPU 51.

The subsequent-stage wakeup-target section 83 implements the subsequent-stage wakeup-target section 13 illustrated in FIG. 1. The subsequent-stage wakeup-target section 83 includes subsequent-stage wakeup elements, such as a video-and-sound recording process 101, a playback process 102, the video output section 57, the sound output section 58, the recording section 59, and the broadcast receiving section 60. The video-and-sound recording process 101 is a process for performing a broadcast-program recording operation executed by the CPU 51, and the playback process is a process for performing a broadcast-program playback operation executed by the CPU 51.

### (Example of Wakeup Table)

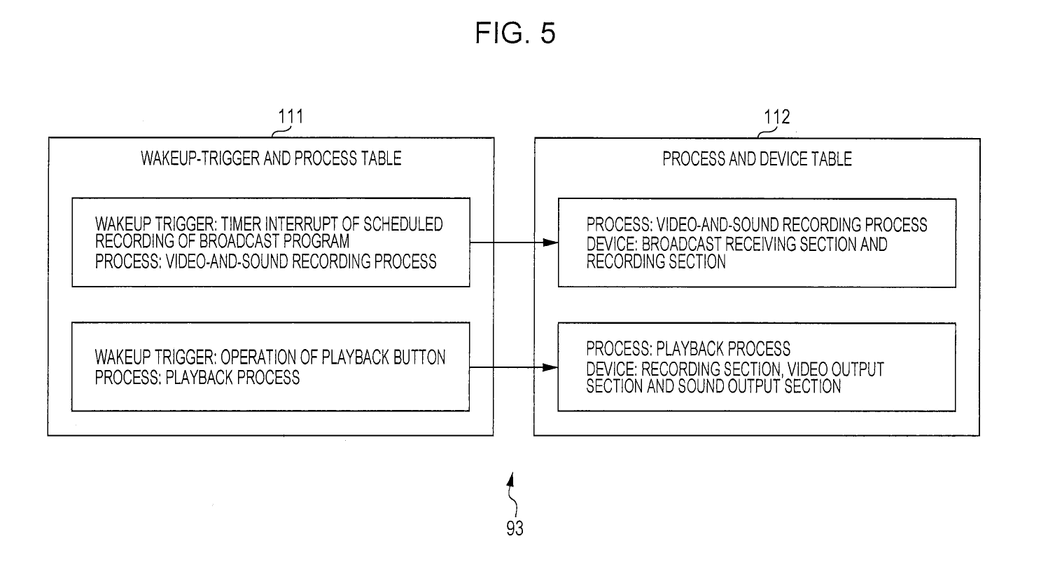

FIG. 5 illustrates an example of the wakeup table 93 illustrated in FIG. 4.

As illustrated in FIG. 5, the wakeup table 93 is constituted by a wakeup-trigger and process table 111 and a process and device table 112. The wakeup-trigger and process table 111 is a table in which wakeup triggers and processes to be woken up during wakeup due to the corresponding wakeup triggers are associated with each other.

In the example in FIG. 5, in the wakeup-trigger and process table 111, a “video-and-sound recording process” is registered in association with a wakeup trigger “timer interrupt of scheduled recording of broadcast program”. A “playback process” is also registered in association with a wakeup trigger “operation of playback button”.

The process and device table 112 is also a table in which processes and devices to be woken up during execution of the processes are associated with each other. In the example in FIG. 5, in the process and device table 112, devices “broadcast receiving section” and “recording section” are registered in association with the “video-and-sound recording process”. Devices “recording section”, “video output section”, and “sound output section” are also registered in association with the “playback process”.

In the wakeup table 93 illustrated in FIG. 5, the wakeup trigger “timer interrupt of scheduled recording of broadcast program” is associated with the “video-and-sound recording process”, the “broadcast receiving section”, and the “recording section”, as described above. The wakeup trigger “operation of playback button” is also associated with the “playback process”, the “recording section”, the “video output section”, and the “sound output section”.

### (Description of Wakeup Processing)

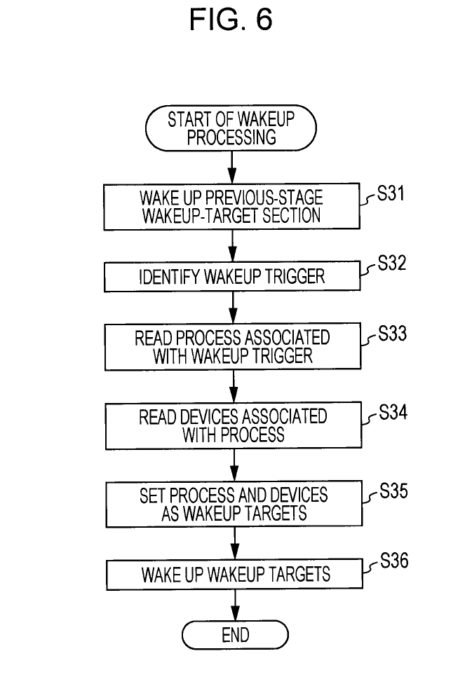

FIG. 6 is a flowchart illustrating wakeup processing performed by the wakeup processing section 80 illustrating FIG. 4. This wakeup processing is initiated when a wakeup trigger occurs in the sleep state.

In step S31 in FIG. 6, the previous-stage wakeup processing section 81 in the wakeup processing section 80 wakes up the previous-stage wakeup-target section 82.

In step S32, the wakeup-trigger identifying section 91 in the previous-stage wakeup-target section 82 identifies a wakeup trigger that has occurred. For example, in a case in which an interrupt-identifying number assigned to the timer interrupt of scheduled recording of a broadcast program is assumed to be “1”, when an interrupt assigned the number “1” occurs, the wakeup-trigger identifying section 91 identifies that the wakeup trigger is the “timer interrupt of scheduled recording of broadcast program”. The wakeup-trigger identifying section 91 supplies information indicating the identified wakeup trigger to the wakeup-target identifying section 92.

In step S33, the wakeup-target identifying section 92 reads, from the wakeup-trigger and process table 111 in the ROM 52, the process associated with the wakeup trigger indicated by the information supplied from the wakeup-trigger identifying section 91.

More specifically, for example, when the current time reaches a time that is a predetermined amount of time earlier than the broadcast start time of a scheduled-recording broadcast program during hibernation to thereby generate the wakeup trigger “timer interrupt of scheduled recording of broadcast program”, the wakeup-target identifying section 92 reads, from the wakeup-trigger and process table 111, the “video-and-sound recording process” associated with the “timer interrupt of scheduled recording of broadcast program”.

On the other hand, when the user operates the playback button of the input section 56 to generate the wakeup trigger “operation of playback button”, the wakeup-target identifying section 92 reads, from the wakeup-trigger and process table 111, the “playback process” associated with the “operation of playback button”.

In step S34, the wakeup-target identifying section 92 reads, from the process and device table 112 in the ROM 52, the devices associated with the process read in step S33.

More specifically, when the “video-and-sound recording process” is read, the wakeup-target identifying section 92 reads, from the process and device table 112, the “broadcast receiving section” and the “recording section” associated with the “video-and-sound recording process”. On the other hand, when the “playback process” is read, the wakeup-target identifying section 92 reads, from the process and device table 112, the “recording section”, the “video output section”, and the “sound output section” associated with the “playback process”.

In step S35, the wakeup-target identifying section 92 sets, as wakeup targets, the process read in step S33 and the devices read in step S34. The wakeup-target identifying section 92 then supplies information indicating the process and devices set as the wakeup targets to the subsequent-stage wakeup processing section 94.

In step S36, the subsequent-stage wakeup processing section 94 wakes up, in the subsequent-stage wakeup-target section 83, the process and devices indicated by the information supplied from the wakeup-target identifying section 92. Thus, when the wakeup trigger is the “timer interrupt of scheduled recording of broadcast program”, only the video-and-sound recording process 101, the recording section 59, and the broadcast receiving section 60 to be used for recording a scheduled broadcast program are woken up. As a result, in accordance with the video-and-sound recording process 101, the CPU 51 causes the broadcast receiving section 60 to receive video and sound of the scheduled broadcast program and causes the recording section 59 to record the video and the sound. After the video-and-sound recording, the recording playback apparatus 50 stops the video-and-sound recording process 101, the recording section 59, and the broadcast receiving section 60, and the state transitions to the hibernation state.

On the other hand, when the wakeup trigger is the “operation of playback button”, only the playback process 102, the recording section 59, the video output section 57, and the sound output section 58 to be used for playing back a broadcast program are woken up. As a result, in accordance with the playback process 102, the CPU 51 reads video and sound of a predetermined broadcast program from the recording section 59, causes the video output section 57 to output the video, and causes the sound output section 58 to output the sound.

As described above, the recording playback apparatus 50 identifies a wakeup target in response to a wakeup trigger and wakes up the wakeup target. Thus, it is possible to wake up only a device and a process to be woken up in response to a wakeup trigger. That is, it is possible to ensure that a device and a process that are not to be woken up are not woken up. As a result, the time taken for the wakeup processing can be reduced, and the power consumption during the wakeup processing can be reduced. In addition, the power consumption after the wakeup processing can be reduced, the time taken for stopping a device and a process that are woken up can be reduced, and the power consumption during the stop processing can be reduced.

### Second Embodiment

### Example Configuration of Second Embodiment of Information Processing Apparatus

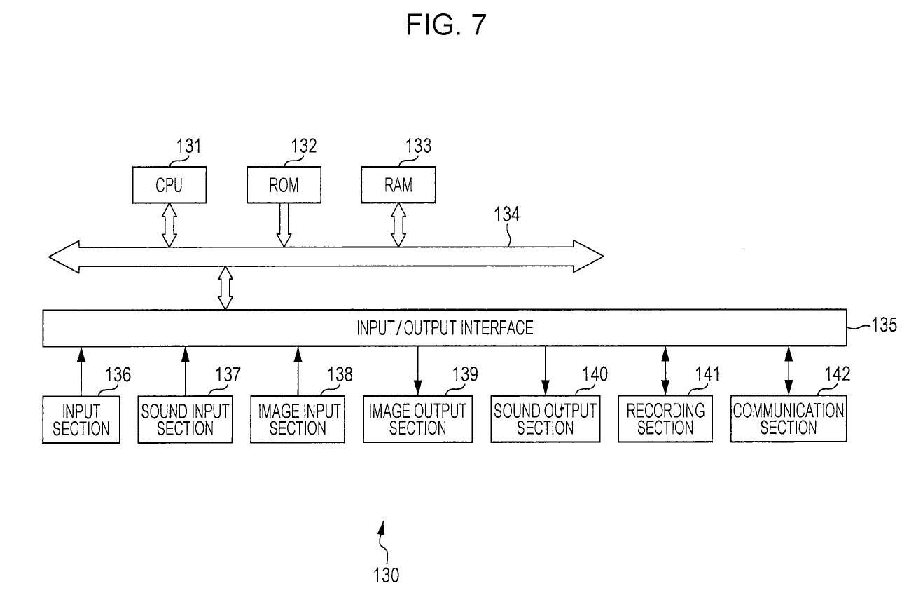

FIG. 7 is a block diagram illustrating an example configuration of a mobile phone according to a second embodiment of the information processing apparatus to which the present technology is applied.

A mobile phone 130 illustrated in FIG. 7 is a smartphone or the like and performs phone call, photography, electronic-mail transmission/reception, web-page display, and so on.

In the mobile phone 130, a CPU 131, a ROM 132, and a RAM 133 are coupled to each other through a bus 134. An input/output interface 135 is further coupled to the bus 134. An input section 136, a sound input section 137, an image input section 138, an image output section 139, a sound output section 140, a recording section 141, and a communication section 142 are coupled to the input/output interface 135.

The CPU 131 performs phone call, photography, electronic-mail transmission/reception, web-page display, and so on, for example, by loading a program recorded in the recording section 141 into the RAM 133 via the input/output interface 135 and the bus 134 and executing the loaded program. During the processing, the CPU 131 refers to information stored in the ROM 132 or writes/reads information to/from the RAM 133, as appropriate.

The input section 136 includes various operation buttons, such as a camera button and a web button. The camera button refers to a button that a user operates to perform photography. The web button refers to a button that the user operates to display a web page.

The sound input section 137 includes a microphone and so on. During phone call, under the control of the CPU 131, the sound input section 137 obtains ambient sound and supplies the sound to the communication section 142 via the input/output interface 135.

The image input section 138 includes a camera and so on. During photography, under the control of the CPU 131 according to an operation of the camera button, the image input section 138 performs photography and supplies a resulting image to the recording section 141, the image output section 139, and so on via the input/output interface 135.

The image output section 139 includes a display and so on. During display of a web page, under the control of the CPU 131 according to an operation of the web button, the image output section 139 displays an image of a web page supplied from the communication section 142. During reception of electronic mail, under the control of the CPU 131, the image output section 139 displays an image of mail data supplied from the communication section 142.

During incoming call, under the control of the CPU 131, the image output section 139 displays an image indicating incoming-call information, such as a caller. During photography, under the control of the CPU 131, the image output section 139 displays, as a live-view image, an image supplied from the image input section 138.

The sound output section 140 includes a speaker and so on. During phone call, under the control of the CPU 131, the sound output section 140 outputs sound and so on supplied from the communication section 142.

The recording section 141 includes a hard disk, a nonvolatile memory, and so on. During photography, under the control of the CPU 131 or the like, the recording section 141 records an image supplied from the image input section 138.

The communication section 142 includes an antenna and so on. During phone call, under the control of the CPU 131 or the like, the communication section 142 receives voice signals and supplies the resulting voice to the sound output section 140, and also transmits voice signals supplied from the sound input section 137. During display of a web page, under the control of the CPU 131 or the like, the communication section 142 also communicates with a web server (not illustrated), receives an image of the web page, and supplies the image to the image output section 139. During reception of electronic mail, under the control of the CPU 131 or the like, the communication section 142 also receives mail data and supplies the mail data to the image output section 139.

The mobile phone 130 configured as described above implements the wakeup processing section 10. A wakeup processing section implemented by the mobile phone 130 will be described below.

### (Example Configuration of Wakeup Processing Section)

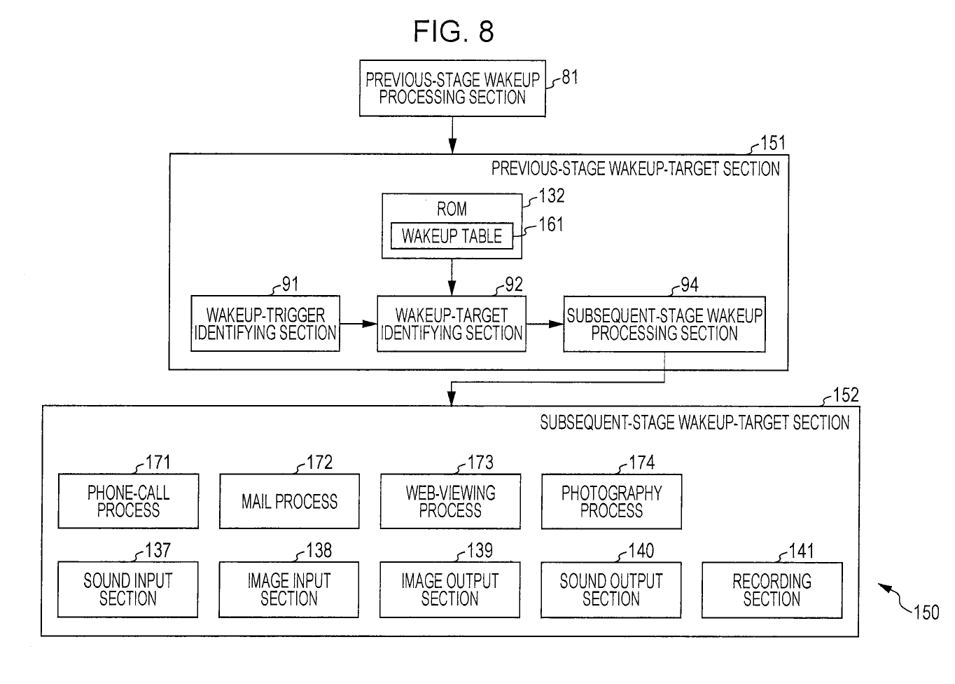

FIG. 8 is a block diagram illustrating an example configuration of a wakeup processing section implemented by the mobile phone 130 illustrated in FIG. 7.

In the sections illustrated in FIG. 8, sections that are the same as or similar to those illustrated in FIG. 4 are denoted by the same reference numerals. Redundant descriptions are not given as appropriate.

The configuration of a wakeup processing section 150 illustrated in FIG. 8 is different from the configuration illustrated in FIG. 4 in that a previous-stage wakeup-target section 151 and a subsequent-stage wakeup-target section 152 are provided instead of the previous-stage wakeup-target section 82 and the subsequent-stage wakeup-target section 83. The configuration of the previous-stage wakeup-target section 151 is also different from the configuration illustrated in FIG. 4 in that, instead of the wakeup table 93, a wakeup table 161 is stored in the ROM 132.

A previous-stage wakeup processing section 81, a wakeup-trigger identifying section 91, a wakeup-target identifying section 92, and a subsequent-stage wakeup processing section 94 in the wakeup processing section 150 are implemented by, for example, the CPU 131 illustrated in FIG. 7.

In the wakeup table 161, wakeup triggers that can occur in the mobile phone 130 and processes and devices that are to be woken up during wakeup due to the corresponding wakeup triggers are associated with each other.

The subsequent-stage wakeup-target section 152 implements the subsequent-stage wakeup-target section 13 illustrated in FIG. 1. The subsequent-stage wakeup-target section 152 includes subsequent-stage wakeup elements, such as a phone-call process 171, a mail process 172, a web-viewing process 173, a photography process 174, the sound input section 137, the image input section 138, the image output section 139, the sound output section 140, and the recording section 141.

The phone-call process 171 is a process for performing a phone-call operation executed by the CPU 131, and the mail process 172 is a process for performing operations for creation, display, and transmission/reception of electronic mail, the operations being performed by the CPU 131. The web-viewing process 173 is a process for performing a web-page output operation executed by the CPU 131, and the photography process 174 is a process for performing a photography operation executed by the CPU 131.

### (Example of Wakeup Table)

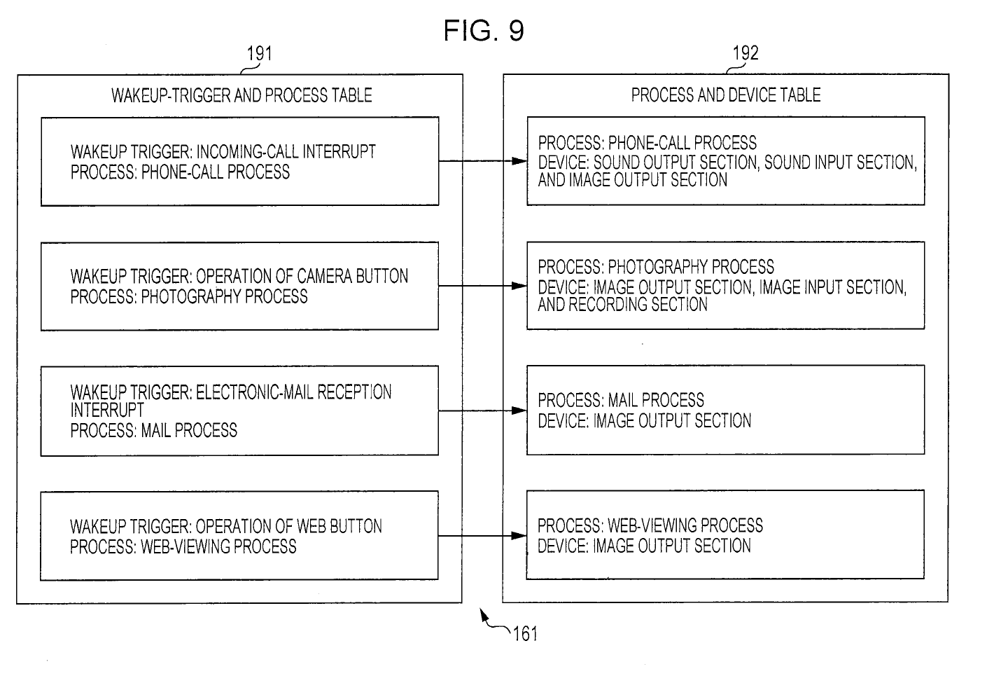

FIG. 9 illustrates an example of the wakeup table 161 illustrated in FIG. 8.

As illustrated in FIG. 9, the wakeup table 161 is constituted by a wakeup-trigger and process table 191 and a process and device table 192, similarly to the wakeup table 93 illustrated in FIG. 5.

In the example in FIG. 9, in the wakeup-trigger and process table 191, a “phone-call process” is registered in association with a wakeup trigger “incoming-call interrupt”, and a “photography process” is registered in association with a wakeup trigger “operation of camera button”. A “mail process” is also registered in association with a wakeup trigger “electronic-mail reception interrupt”, and a “web-viewing process” is registered in association with a wakeup trigger “operation of web button”.

In the example in FIG. 9, in the process and device table 192, devices “sound output section”, “sound input section”, and “image output section” are registered in association with the “phone-call process”. Devices “image output section”, “image input section”, and “recording section” are also registered in association with the “photography process”. The device “image output section” is also registered in association with the “mail process” and the “web-viewing process”.

As described above, in the wakeup table 161 in FIG. 9, the wakeup trigger “incoming-call interrupt” is associated with the “phone-call process”, the “sound output section”, the “sound input section”, and the “image output section”. The wakeup trigger “operation of camera button” is also associated with the “photography process”, the “image output section”, the “image input section”, and the “recording section”.

The wakeup trigger “electronic-mail reception interrupt” is also associated with the “mail process” and the “image output section”. The wakeup trigger “operation of web button” is also associated with the “web-viewing process” and the “image output section”.

Since the wakeup processing performed by the mobile phone 130 is analogous to the wakeup processing illustrated in FIG. 6, a description thereof is not given hereinafter.

In this wakeup processing, for example, when a phone call is received during suspension and an incoming-call interrupt occurs, it is identified that the wakeup trigger is “incoming-call interrupt”. More specifically, for example, in a case in which an interrupt-identifying number assigned to the incoming-call interrupt is assumed to be “2”, when an interrupt assigned the number “2” occurs, the wakeup-trigger identifying section 91 identifies that the wakeup trigger is the “incoming-call interrupt”. As a result, the phone-call process 171, the sound output section 140, the sound input section 137, and the image output section 139 are woken up, and the state of the mobile phone 130 transitions to a state in which a phone-call operation can be performed.

As a result, in accordance with the phone-call process 171, the CPU 131 causes the image output section 139 to display an image indicating incoming-call information and causes the sound output section 140 to output voice of the phone call received by the communication section 142. In accordance with the phone-call process 171, the CPU 131 transmits signals of phone-call voice, obtained by the sound input section 137, via the communication section 142. After the phone call is finished, the mobile phone 130 stops the phone-call process 171, the sound output section 140, the sound input section 137, and the image output section 139, and the state transitions to a hibernation state.

In the wakeup processing, for example, when a user operates the camera button of the input section 136 during suspension to generate the wakeup trigger “operation of camera button”, the photography process 174, the image output section 139, the image input section 138, and the recording section 141 are woken up. As a result, in accordance with the photography process 174, the CPU 131 causes the image input section 138 to perform photography, causes the image output section 139 to display a resulting image as a live-view image, and causes the recording section 141 to record the image.

In the wakeup processing, for example, when electronic mail is received to generate the wakeup trigger “electronic-mail reception interrupt”, the mail process 172 and the image output section 139 are woken up. As a result, in accordance with the mail process 172, the CPU 131 causes the image output section 139 to display an image associated with the mail data received by the communication section 142. Thereafter, the mobile phone 130 stops the mail process 172 and the image output section 139, and the state transitions to the hibernation state.

In the wakeup processing, for example, when the user operates the web button of the input section 136 to generate the wakeup trigger “operation of web button”, the web-viewing process 173 and the image output section 139 are woken up. As a result, in accordance with the web-viewing process 173, the CPU 131 causes the communication section 142 to receive a web page and causes the image output section 139 to display an image of the received web page.

As described above, the mobile phone 130 identifies wakeup targets in response to a wakeup trigger and wakes up the wakeup targets. Accordingly, similarly to the recording playback apparatus 50, it is possible to reduce the time taken for the wakeup processing, the power consumption during the wakeup processing, the power consumption after the wakeup processing, the time taken for stop processing for already-woken-up devices or processes, the power consumption during the stop processing, and so on.

### Third Embodiment

### Example Configuration of Third Embodiment of Information Processing Apparatus

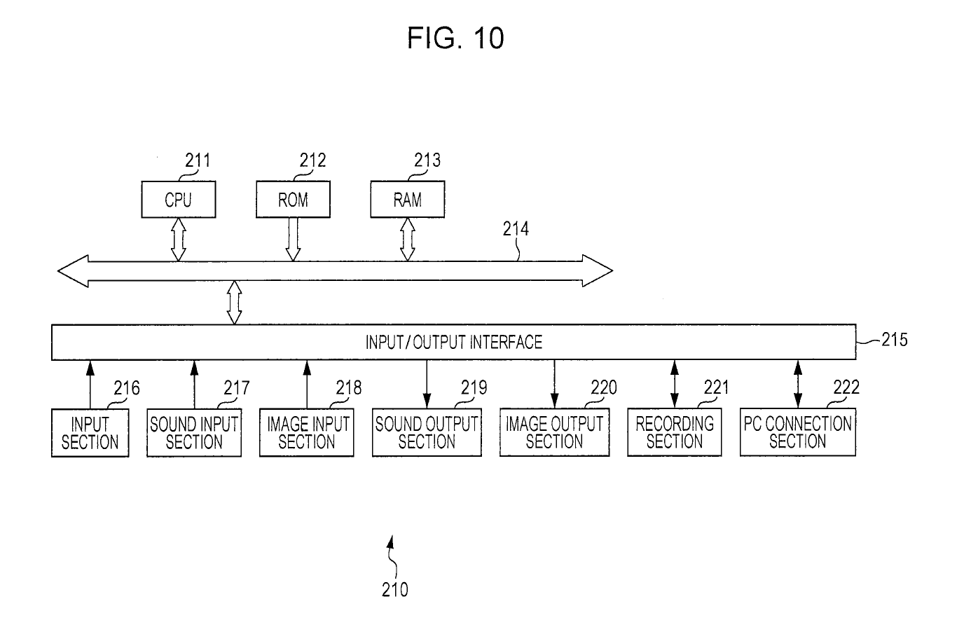

FIG. 10 is a block diagram illustrating an example configuration of a digital camera according to a third embodiment of the information processing apparatus to which the present technology is applied.

A digital camera 210 illustrated in FIG. 10 performs photography of a still image and a moving image, display thereof, and so on. In the digital camera 210, a CPU 211, a ROM 212, and a RAM 213 are coupled to each other through a bus 214. An input/output interface 215 is further coupled to the bus 214. An input section 216, a sound input section 217, an image input section 218, a sound output section 219, an image output section 220, a recording section 221, and a personal computer (PC) connection section 222 are coupled to the input/output interface 215.

The CPU 211 performs photography of a still image and a moving image, display thereof, and so on, for example, by loading a program recorded in the recording section 221 into the RAM 213 via the input/output interface 215 and the bus 214 and executing the loaded program. During the processing, the CPU 211 refers to information stored in the ROM 212 or writes/reads information to/from the RAM 213, as appropriate.

The input section 216 includes various operation buttons, such as a mode button, a power button, and so on. The mode button is a button that a user operates to select an operation mode of the digital camera 210. Examples of the operation mode include a still-image photography mode for photographing a still image, a moving-image photography mode for photographing a moving image, a still-image viewing mode for displaying a still image, and a moving-image viewing mode for displaying a moving image. The power button is a button that the user operates to turn on or off the power of the digital camera 210.

The sound input section 217 includes a microphone and so on. In the moving-image photography mode, under the control of the CPU 211, the sound input section 217 obtains ambient sound and supplies the obtained sound to the recording section 221 via the input/output interface 215.

The image input section 218 includes a photographing section and so on. In the moving-image photography mode, under the control of the CPU 211, the image input section 218 performs photography for a predetermined period of time and supplies, as a moving image, the photographed image to the image output section 220 and the recording section 221 via the input/output interface 215.

In the still-image photography mode, under the control of the CPU 211, the image input section 218 also performs photography and outputs, as a live-view image, the image being photographed to the image output section 220 via the input/output interface 215. The image input section 218 then supplies, as a still image, the image photographed at a predetermined timing to the recording section 221 via the input/output interface 215.

The sound output section 219 includes a speaker and so on. In the moving-image viewing mode, under the control of the CPU 211, the sound output section 219 outputs, for example, sound associated with a moving image supplied from the recording section 221.

The image output section 220 includes a display and so on. In the moving-image viewing mode, under the control of the CPU 211, the image output section 220 displays a moving image or the like supplied from the recording section 221. In the still-image viewing mode, under the control of the CPU 211, the image output section 220 also displays a still image or the like supplied from the recording section 221.

The recording section 221 includes a hard disk, a nonvolatile memory, and so on. In the moving-image photography mode, under the control of the CPU 211 or the like, the recording section 221 records sound supplied from the sound input section 217 and moving image supplied from the image input section 218. In the still-image photography mode, under the control of the CPU 211 or the like, the recording section 221 also records a still image supplied from the image input section 218.

In the moving-image viewing mode, under the control of the CPU 211 or the like, the recording section 221 also reads a recorded moving image and sound associated with the moving image, supplies the moving image to the image output section 220, and also supplies the sound to the sound output section 219. In the still-image viewing mode, under the control of the CPU 211 or the like, the recording section 221 reads a recorded still image and supplies the read still image to the image output section 220.

The PC connection section 222 includes a Universal Serial Bus (USB) interface and so on. During connection with a PC or the like, under the control of the CPU 211 or the like, the PC connection section 222 transmits, for example, a still image or a moving image and sound associated with the moving image, the images and sound being recorded in the recording section 221, to the PC.

The digital camera 210 configured as described above implements the wakeup processing section 10. A wakeup processing section implemented by the digital camera 210 will be described below.

### (Example Configuration of Wakeup Processing Section)

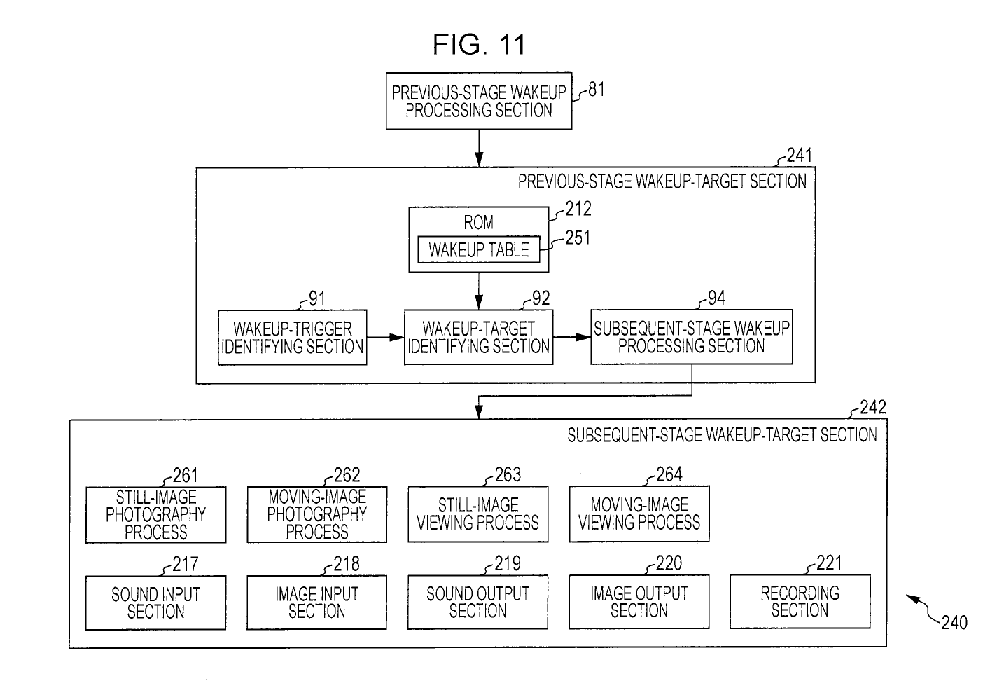

FIG. 11 is a block diagram illustrating an example configuration of a wakeup processing section implemented by the digital camera 210 illustrated in FIG. 10.

In the sections illustrated in FIG. 11, sections that are the same as or similar to those illustrated in FIG. 4 are denoted by the same reference numerals. Redundant descriptions are not given as appropriate.

The configuration of a wakeup processing section 240 illustrated in FIG. 11 is different from the configuration illustrated in FIG. 4 in that a previous-stage wakeup-target section 241 and a subsequent-stage wakeup-target section 242 are provided instead of the previous-stage wakeup-target section 82 and the subsequent-stage wakeup-target section 83. The configuration of the previous-stage wakeup-target section 241 is also different from the configuration illustrated in FIG. 4 in that, instead of the wakeup table 93, a wakeup table 251 is stored in the ROM 212.

A previous-stage wakeup processing section 81, a wakeup-trigger identifying section 91, a wakeup-target identifying section 92, and a subsequent-stage wakeup processing section 94 in the wakeup processing section 240 are implemented by, for example, the CPU 211 illustrated in FIG. 10.

In the wakeup table 251, wakeup triggers that can occur in the digital camera 210 and processes and devices that are to be woken up during wakeup due to the corresponding wakeup triggers are associated with each other.

The subsequent-stage wakeup-target section 242 implements the subsequent-stage wakeup-target section 13 illustrated in FIG. 1. The subsequent-stage wakeup-target section 242 includes subsequent-stage wakeup elements, such as a still-image photography process 261, a moving-image photography process 262, a still-image viewing process 263, a moving-image viewing process 264, the sound input section 217, the image input section 218, the sound output section 219, the image output section 220, and the recording section 221.

The still-image photography process 261 is a process for performing a still-image photography operation executed by the CPU 211, and the moving-image photography process 262 is a process for performing a moving-image photography operation executed by the CPU 211. The still-image viewing process 263 is a process for performing a still-image output operation executed by the CPU 211, and the moving-image viewing process 264 is a process for performing a moving-image output operation executed by the CPU 211.

### (Example of Wakeup Table)

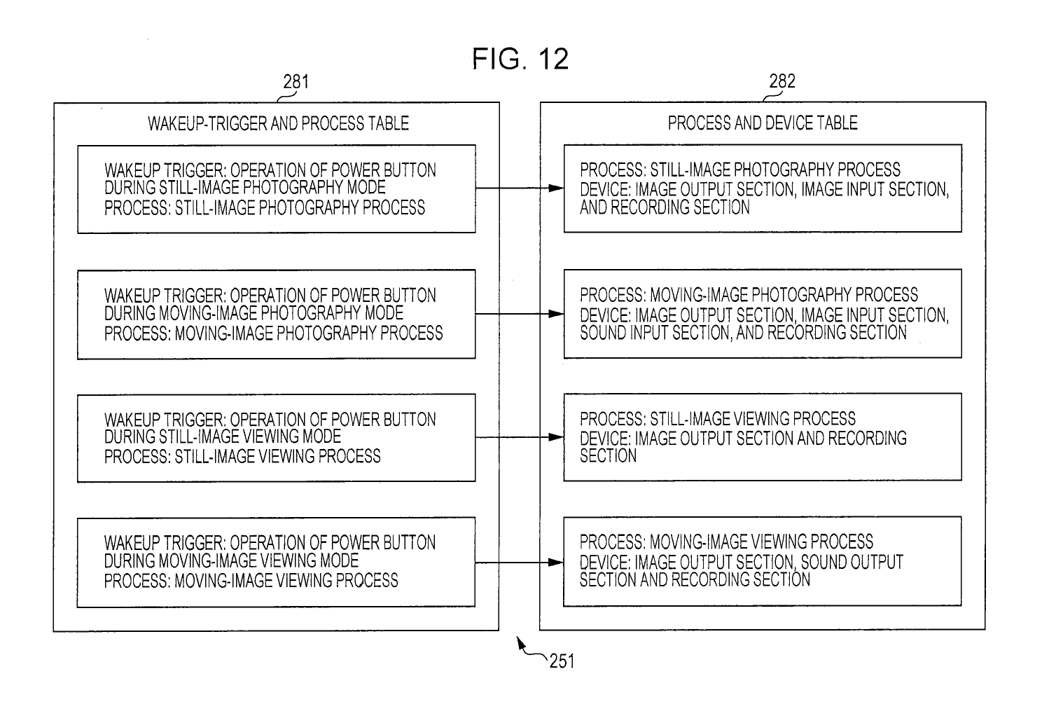

FIG. 12 illustrates an example of the wakeup table 251 illustrated in FIG. 11.

As illustrated in FIG. 12, the wakeup table 251 is constituted by a wakeup-trigger and process table 281 and a process and device table 282, similarly to the wakeup table 93 illustrated in FIG. 5.

In the example illustrated in FIG. 12, in the wakeup-trigger and process table 281, a “still-image photography process” is registered in association with a wakeup trigger “operation of power button during still-image photography mode”. A “moving-image photography process” is also registered in association with a wakeup trigger “operation of power button during moving-image photography mode”.

A “still-image viewing process” is also registered in association with a wakeup trigger “operation of power button during still-image viewing mode”, and a “moving-image viewing process” is registered in association with a wakeup trigger “operation of power button during moving-image viewing mode”.

In the example in FIG. 12, in the process and device table 282, devices “image output section”, “image input section”, and “recording section” are registered in association with the “still-image photography process”. Devices “image output section”, “image input section”, “sound input section”, and “recording section” are also registered in association with the “moving-image photography process”.

The devices “image output section” and “recording section” are registered in association with the “still-image viewing process”, and the devices “image output section”, “sound output section, and “recording section” are registered in association with the “moving-image viewing process”.

As described above, in the wakeup table 251 illustrated in FIG. 12, the wakeup trigger “operation of power button during still-image photography mode” is associated with the “still-image photography process”, the “image output section” the “image input section”, and the “recording section”. The wakeup trigger “operation of power button during moving-image photography mode” is also associated with the “moving-image photography process”, the “image output section”, the “image input section”, the “sound input section”, and the “recording section”.

In the wakeup table 251, the wakeup trigger “operation of power button during still-image viewing mode” is associated with the “still-image viewing process”, the “image output section”, and the “recording section”. The wakeup trigger “operation of power button during moving-image viewing mode” is also associated with the “moving-image viewing process”, the “image output section”, the “sound output section”, and the “recording section”.

Since wakeup processing performed by the digital camera 210 is analogous to the wakeup processing illustrated in FIG. 6, a description thereof is not given hereinafter.

In the wakeup processing, for example, when a user operates the power button during the still-image photography mode to generate the wakeup trigger “operation of power button during still-image photography mode”, the still-image photography process 261, the image output section 220, the image input section 218, and the recording section 221 are woken up. As a result, in accordance with the still-image photography process 261, the CPU 211 causes the image input section 218 to perform photography, causes the image output section 220 to display a resulting live-view image, and causes the recording section 221 to record a still image.

In the wakeup processing, for example, when the user operates the power button during the moving-image photography mode to generate the wakeup trigger “operation of power button during moving-image photography mode”, the moving-image photography process 262, the image output section 220, the image input section 218, the sound input section 217, and the recording section 221 are woken up. As a result, in accordance with the moving-image photography process 262, the CPU 211 causes the image input section 218 to perform photography, causes the sound input section 217 to obtain sound, and causes the recording section 221 to record a resulting moving image and the sound.

In the wakeup processing, for example, when the user operates the power button during the still-image viewing mode to generate the wakeup trigger “operation of power button during still-image viewing mode”, the still-image viewing process 263, the image output section 220, and the recording section 221 are woken up. As a result, in accordance with the still-image viewing process 263, the CPU 211 reads a predetermined still image from the recording section 221 and causes the image output section 220 to display the read still image.

In the wakeup processing, for example, when the user operates the power button during the moving-image viewing mode to generate the wakeup trigger “operation of power button during moving-image viewing mode”, the moving-image viewing process 264, the image output section 220, the sound output section 219, and the recording section 221 are woken up. As a result, in accordance with the moving-image viewing process 264, the CPU 211 reads a predetermined moving image and corresponding sound from the recording section 221, causes the image output section 220 to display the moving image, and causes the sound output section 219 to output the sound.

As described above, the digital camera 210 identifies wakeup targets in response to a wakeup trigger and wakes up the wakeup targets. Accordingly, similarly to the recording playback apparatus 50, it is possible to reduce the time taken for the wakeup processing, the power consumption during the wakeup processing, the power consumption after the wakeup processing, the time taken for stop processing for already-woken-up devices or processes, the power consumption during the stop processing, and so on.

### Fourth Embodiment

### Example Configuration of Fourth Embodiment of Information Processing Apparatus

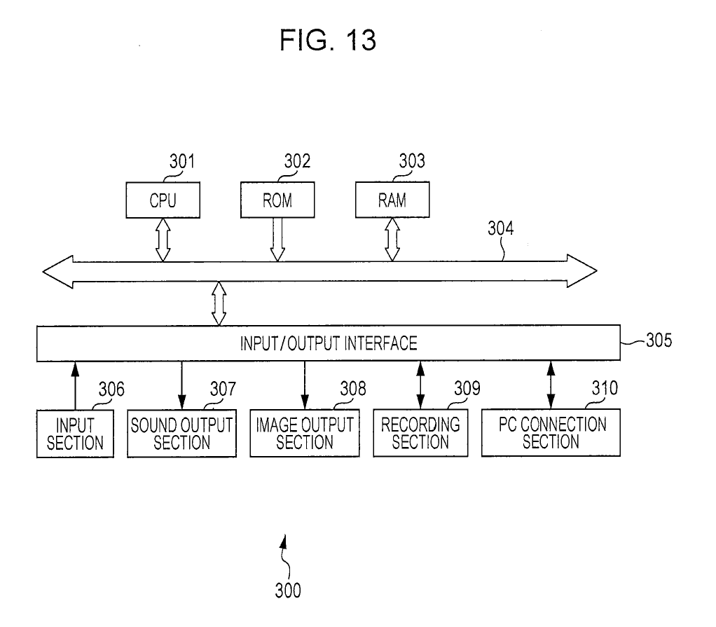

FIG. 13 is a block diagram illustrating an example configuration of portable audio equipment according to a fourth embodiment of the information processing apparatus to which the present technology is applied.

Portable audio equipment 300 illustrated in FIG. 13 performs playback of music, charging using a PC, and so on. In the portable audio equipment 300, a CPU 301, a ROM 302, and a RAM 303 are coupled to each other through a bus 304. An input/output interface 305 is further coupled to the bus 304. An input section 306, a sound output section 307, an image output section 308, a recording section 309, and a PC connection section 310 are coupled to the input/output interface 305.

The CPU 301 performs playback of music, charging using a PC, and so on, for example, by loading a program recorded in the recording section 309 into the RAM 303 through the input/output interface 305 and the bus 304 and executing the loaded program. During the processing, the CPU 301 refers to information recorded in the ROM 302 or writes/reads information to/from the RAM 303, as appropriate.

The input section 306 includes various operation buttons, such as a playback button. The playback button refers to a button that a user operates to play back music recorded in the recording section 309.

The sound output section 307 includes a speaker and so on. During playback of music, under the control of the CPU 301, the sound output section 307 outputs music supplied from the recording section 309.

The image output section 308 includes a display and so on. During playback of music, under the control of the CPU 301, the image output section 308 displays, for example, an image associated with music supplied from the recording section 309. During charging using a PC, under the control of the CPU 301, the image output section 308 also displays an image indicating the state of a battery (not illustrated) built into the portable audio equipment 300.

The recording section 309 includes a hard disk, a nonvolatile memory, and so on. The recording section 309 records music, an image associated with the music, and so on. During playback of music, under the control of the CPU 301 or the like, the recording section 309 reads recorded music and a corresponding image and a corresponding image, supplies the music to the sound output section 307, and supplies the image to the image output section 308.

When the portable audio equipment 300 is inserted in a cradle (not illustrated), the PC connection section 310 connects to a PC (not illustrated) via the cradle to charge the battery (not illustrated) with power transmitted from the PC.

The portable audio equipment 300 configured as described above implements the wakeup processing section 10. A wakeup processing section implemented by the portable audio equipment 300 will be described below.

### (Example Configuration of Wakeup Processing Section)

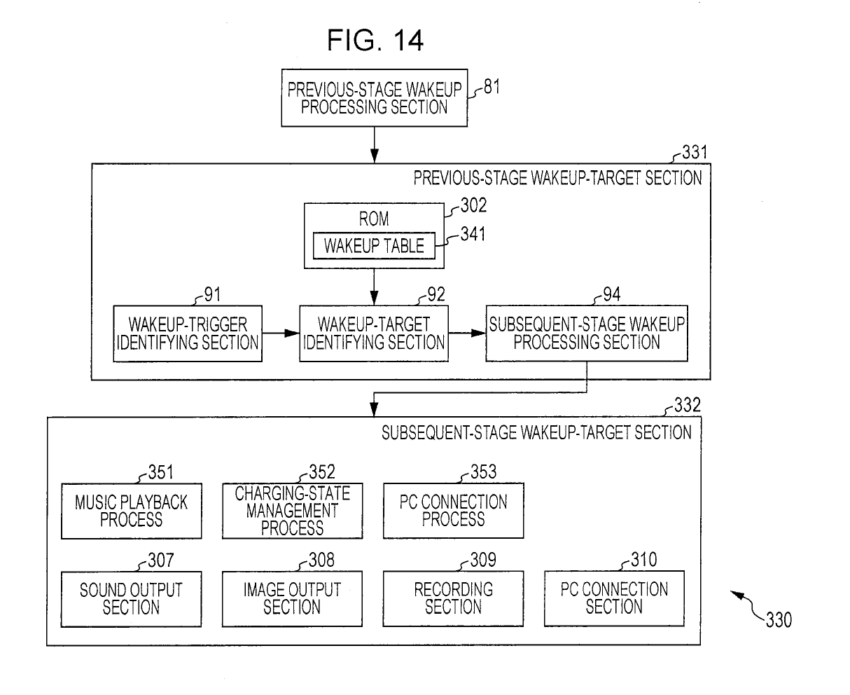

FIG. 14 is a block diagram illustrating an example configuration of a wakeup processing section implemented by the portable audio equipment 300 illustrated in FIG. 13.

In the sections illustrated in FIG. 14, sections that are the same as or similar to those illustrated in FIG. 4 are denoted by the same reference numerals. Redundant descriptions are not given as appropriate.

The configuration of a wakeup processing section 330 illustrated in FIG. 14 is different from the configuration illustrated in FIG. 4 in that a previous-stage wakeup-target section 331 and a subsequent-stage wakeup-target section 332 are provided instead of the previous-stage wakeup-target section 82 and the subsequent-stage wakeup-target section 83. The configuration of the previous-stage wakeup-target section 331 is also different from the configuration illustrated in FIG. 4 in that, instead of the wakeup table 93, a wakeup table 341 is stored in the ROM 302.

A previous-stage wakeup processing section 81, a wakeup-trigger identifying section 91, a wakeup-target identifying section 92, and a subsequent-stage wakeup processing section 94 in the wakeup processing section 330 are implemented by, for example, the CPU 301 illustrated in FIG. 13.

In the wakeup table 341, wakeup triggers that can occur in the portable audio equipment 300 and processes and devices that are to be woken up during wakeup due to the corresponding wakeup triggers are associated with each other.

The subsequent-stage wakeup-target section 332 implements the subsequent-stage wakeup-target section 13 illustrated in FIG. 1. The subsequent-stage wakeup-target section 332 includes subsequent-stage wakeup elements, such as a music playback process 351, a charging-state management process 352, a PC connection process 353, the sound output section 307, the image output section 308, the recording section 309, and the PC connection section 310.

The music playback process 351 is a process for performing a music playback operation executed by the CPU 301, and the charging-state management process 352 is a process for performing a charging-state management operation executed by the CPU 301. The PC connection process 353 is a process for performing a PC connection operation executed by the CPU 301.

### (Example of Wakeup Table)

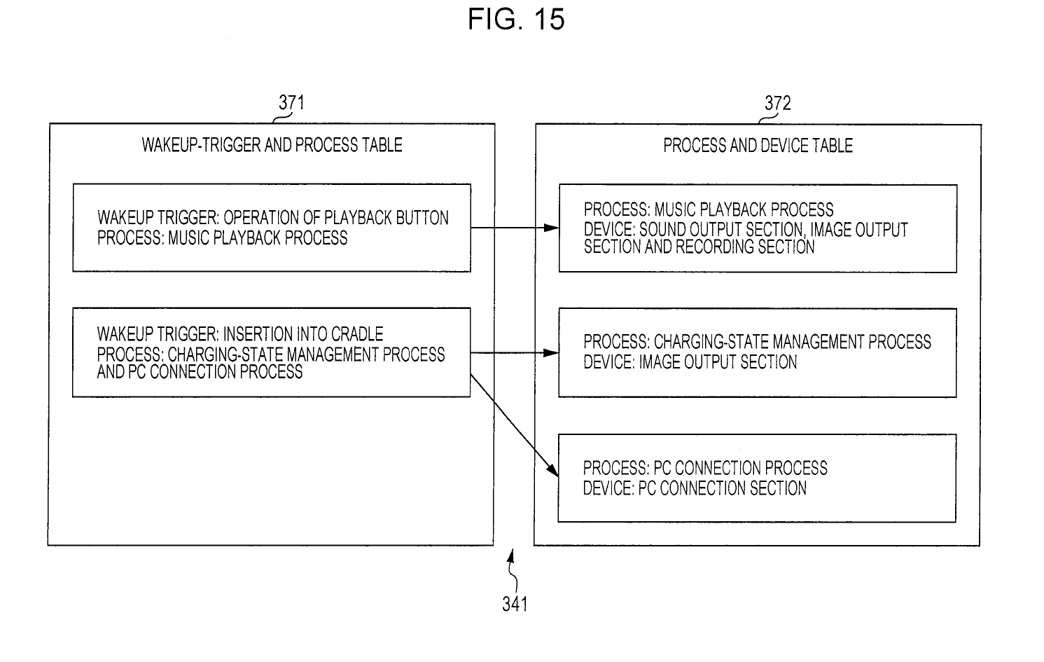

FIG. 15 illustrates an example of the wakeup table 341 illustrated in FIG. 14.

As illustrated in FIG. 15, the wakeup table 341 includes a wakeup-trigger and process table 371 and a process and device table 372, similarly to the wakeup table 93 illustrated in FIG. 5.

In the example illustrated in FIG. 15, in the wakeup-trigger and process table 371, a “music playback process” is registered in association with a wakeup trigger “operation of playback button”. A “charging-state management process” and a “PC connection process” are also registered in association with a wakeup trigger “insertion into cradle”.

In the example in FIG. 15, in the process and device table 372, devices “sound output section”, “image output section”, and “recording section” are associated with the “music playback process”. The device “image output section” is registered in association with the “charging-state management process”, and a device “PC connection section” is registered in association with the “PC connection process”.

As described above, in the wakeup table 341 illustrated in FIG. 15, the wakeup trigger “operation of playback button” is associated with the “music playback process”, the “sound output section”, the “image output section”, and the “recording section”. The wakeup trigger “insertion into cradle” is associated with the “charging-state management process”, the “PC connection process”, the “image output section”, and the “PC connection section”.

Since wakeup processing performed by the portable audio equipment 300 is analogous to the wakeup processing illustrated in FIG. 6, a description thereof is not given hereinafter.

In the wakeup processing, for example, when the user operates the playback button to generate the wakeup trigger “operation of playback button”, the music playback process 351, the sound output section 307, the image output section 308, and the recording section 309 are woken up. As a result, in accordance with the music playback process 351, the CPU 301 reads music and a corresponding image which are recorded in the recording section 309, causes the sound output section 307 to output the music, and causes the image output section 308 to display the image.

In the wakeup processing, for example, when the user inserts the portable audio equipment 300 into the cradle to generate the wakeup trigger “insertion into cradle”, the charging-state management process 352, the PC connection process 353, the image output section 308, and the PC connection section 310 are woken up.

As a result, in accordance with the charging-state management process 352, the CPU 301 causes the image output section 308 to display an image indicating the state of the battery (not illustrated). In accordance with the PC connection process 353, the CPU 301 causes the PC connection section 310 to receive power from the PC and to charge the battery with the power.

As described above, the portable audio equipment 300 identifies wakeup targets in response to a wakeup trigger and wakes up the wakeup targets. Accordingly, similarly to the recording playback apparatus 50, it is possible to reduce the time taken for the wakeup processing, the power consumption during the wakeup processing, the power consumption after the wakeup processing, the time taken for stop processing for already-woken-up devices or processes, the power consumption during the stop processing, and so on.

### Fifth Embodiment

### Example Configuration of Fifth Embodiment of Information Processing Apparatus

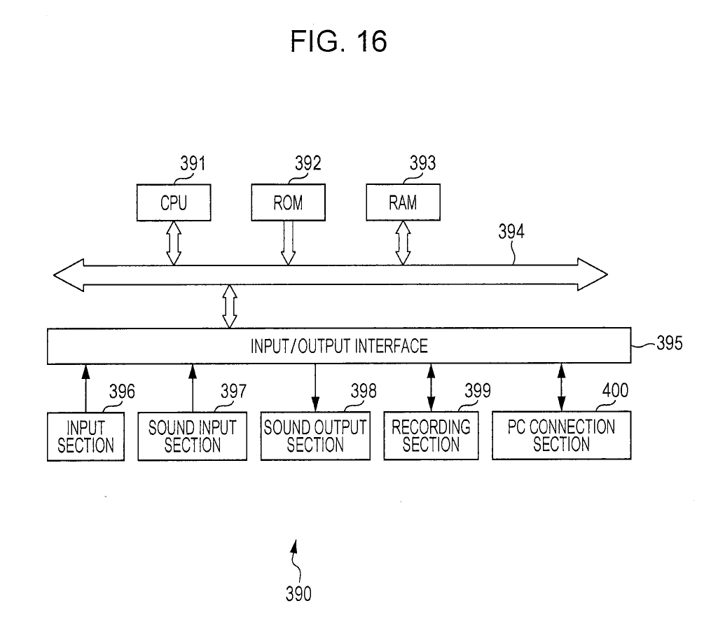

FIG. 16 is a block diagram illustrating an example configuration of an integrated circuit (IC) recorder according to a fifth embodiment of the information processing apparatus to which the present technology is applied.

An IC recorder 390 illustrated in FIG. 16 performs recording of sound, playback thereof, and so on. In the IC recorder 390, a CPU 391, a ROM 392, and a RAM 393 are coupled to each other through a bus 394. An input/output interface 395 is further coupled to the bus 394. An input section 396, a sound input section 397, a sound output section 398, a recording section 399, and a PC connection section 400 are coupled to the input/output interface 395.

The CPU 391 performs recording of sound, playback thereof, and so on, for example, by loading a program recorded in the recording section 399 into the RAM 393 via the input/output interface 395 and the bus 394 and executing the loaded program. During the processing, the CPU 391 refers to information stored in the ROM 392 or writes/reads information to/from the RAM 393, as appropriate.

The input section 396 includes various operation buttons, such as a sound-recording button and a playback button. The sound-recording button is a button that the user operates to record sound (voice) to the recording section 399, and the playback button is a button that the user operates to play back sound recorded in the recording section 399.

The sound input section 397 includes a microphone and so on. During sound recording, under the control of the CPU 391, the sound input section 397 obtains ambient sound and supplies the sound to the recording section 399.

The sound output section 398 includes a speaker and so on. During playback of sound, under the control of the CPU 391, the sound output section 398 outputs sound supplied from the recording section 399.

The recording section 399 includes a hard disk, a nonvolatile memory, and so on. During sound recording, the recording section 399 records sound supplied from the sound input section 397. During playback of sound, under the control of the CPU 391 or the like, the recording section 399 also supplies recorded sound to the sound output section 398.

The PC connection section 400 includes a USB interface and so on and communicates with a PC (not illustrated).

The IC recorder 390 configured as described above implements the wakeup processing section 10. A wakeup processing section implemented by the IC recorder 390 will be described below.

### (Example Configuration of Wakeup Processing Section)

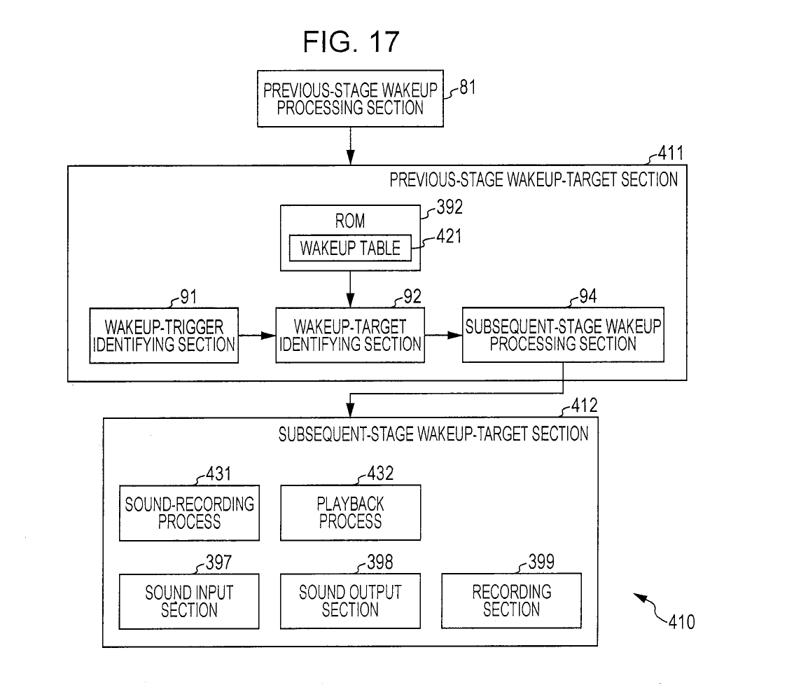

FIG. 17 is a block diagram illustrating an example configuration of a wakeup processing section implemented by the IC recorder 390 illustrated in FIG. 16.

In the sections illustrated in FIG. 17, sections that are the same as or similar to those illustrated in FIG. 4 are denoted by the same reference numerals. Redundant descriptions are not given as appropriate.

The configuration of a wakeup processing section 410 illustrated in FIG. 17 is different from the configuration illustrated in FIG. 4 in that a previous-stage wakeup-target section 411 and a subsequent-stage wakeup-target section 412 are provided instead of the previous-stage wakeup-target section 82 and the subsequent-stage wakeup-target section 83. The configuration of the previous-stage wakeup-target section 411 is different from the configuration illustrated in FIG. 4 in that, instead of the wakeup table 93, a wakeup table 421 is stored in the ROM 392.

A previous-stage wakeup processing section 81, a wakeup-trigger identifying section 91, a wakeup-target identifying section 92, the wakeup table 421 stored in the ROM 392, and a subsequent-stage wakeup processing section 94 in the wakeup processing section 410 are implemented by, for example, the CPU 391 illustrated in FIG. 16.

In the wakeup table 421, wakeup triggers that can occur in the IC recorder 390 and processes and devices that are to be woken up during wakeup due to the corresponding wakeup triggers are associated with each other.

The subsequent-stage wakeup-target section 412 implements the subsequent-stage wakeup-target section 13 illustrated in FIG. 1. The subsequent-stage wakeup-target section 412 includes subsequent-stage wakeup elements, such as a sound-recording process 431, a playback process 432, the sound input section 397, the sound output section 398, and the recording section 399.

The sound-recording process 431 is a process for performing a sound-recording operation executed by the CPU 391, and the playback process 432 is a process for performing a sound playback operation executed by the CPU 391.

### (Example of Wakeup Table)

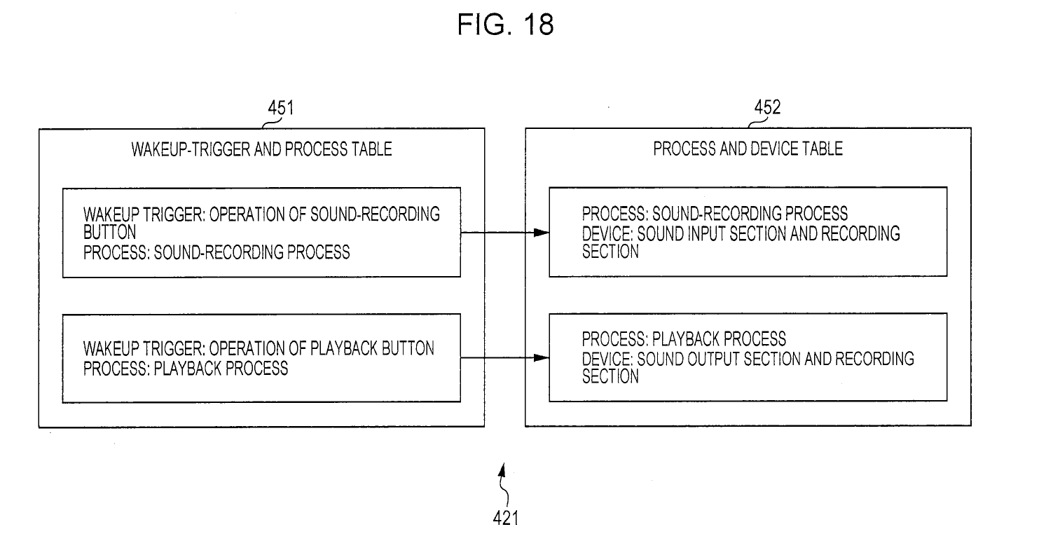

FIG. 18 illustrates an example of the wakeup table 421 illustrated in FIG. 17.

As illustrated in FIG. 18, the wakeup table 421 includes a wakeup-trigger and process table 451 and a process and device table 452, similarly to the wakeup table 93 illustrated in FIG. 5.

In the example in FIG. 18, in the wakeup-trigger and process table 451, a “sound-recording process” is registered in association with a wakeup trigger “operation of sound-recording button”, and a “playback process” is registered in association with the wakeup trigger “operation of playback button”.

In the example illustrated in FIG. 18, in the process and device table 452, devices “sound input section” and “recording section” are associated with the “sound-recording process”, and devices “sound output section” and “recording section” are registered in association with the “playback process”.

As described above, in the wakeup table 421 illustrated in FIG. 18, the wakeup trigger “operation of sound-recording button” is associated with the “sound-recording process”, the “sound input section”, and the “recording section”. The wakeup trigger “operation of playback button” is also associated with the “playback process”, the “sound output section”, and the “recording section”.

Since wakeup processing performed by the IC recorder 390 is analogous to the wakeup processing illustrated in FIG. 6, a description thereof is not given hereinafter.

In the wakeup processing, for example, when the user operates the sound-recording button to generate the wakeup trigger “operation of sound-recording button”, the sound-recording process 431, the sound input section 397, and the recording section 399 are woken up. As a result, in accordance with the sound-recording process 431, the CPU 391 causes the sound input section 397 to obtain sound and causes the recording section 399 to record the sound.

In the wakeup processing, for example, when the user operates the playback button to generate the wakeup trigger “operation of playback button”, the playback process 432, the sound output section 398, and the recording section 399 are woken up. As a result, in accordance with the playback process 432, the CPU 391 reads sound recorded in the recording section 399 and causes the sound output section 398 to output the sound.

As described above, the IC recorder 390 identifies wakeup targets in response to a wakeup trigger and wakes up the wakeup targets. Accordingly, similarly to the recording playback apparatus 50, it is possible to reduce the time taken for the wakeup processing, the power consumption during the wakeup processing, the power consumption after the wakeup processing, the time taken for stop processing for already-woken-up devices or processes, the power consumption during the stop processing, and so on.

### Sixth Embodiment

### Example Configuration of Sixth Embodiment of Information Processing Apparatus

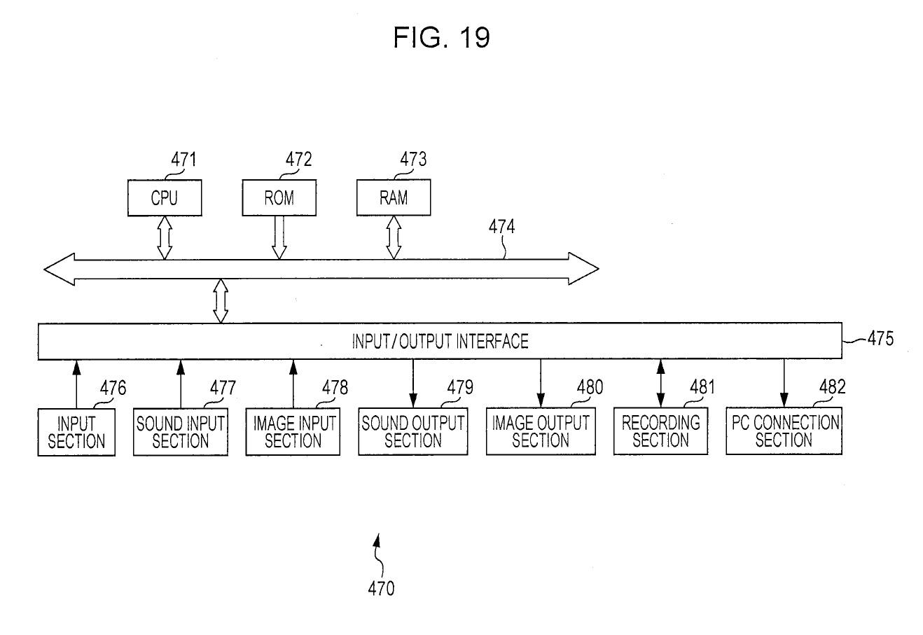

FIG. 19 is a block diagram illustrating an example configuration of a video camera according to a sixth embodiment of the information processing apparatus to which the present technology is applied.

A video camera 470 illustrated in FIG. 19 performs photography of a moving image, playback thereof, and so on. In the video camera 470, a CPU 471, a ROM 472, and a RAM 473 are coupled to each other through a bus 474. An input/output interface 475 is further coupled to the bus 474. An input section 476, a sound input section 477, an image input section 478, a sound output section 479, an image output section 480, a recording section 481, and a PC connection section 482 are coupled to the input/output interface 475.

The CPU 471 performs photography of a moving image, playback thereof, and so on, for example, by loading a program recorded in the recording section 481 into the RAM 473 via the input/output interface 475 and the bus 474 and executing the loaded program. During the processing, the CPU 471 refers to information stored in the ROM 472 or writes/reads information to/from the RAM 473, as appropriate.

The input section 476 includes various operation buttons, such as a recording button and a playback button. The recording button is a button that a user operates to photograph a moving image. The playback button is a button that the user operates to play back a moving image recorded in the recording section 481.

The sound input section 477 includes a microphone and so on. During photography of a moving image, under the control of the CPU 471, the sound input section 477 obtains ambient sound and supplies the sound to the recording section 481. The image input section 478 includes a photographing section and so on. During photography of a moving image, under the control of the CPU 471, the image input section 478 performs photography for a predetermined time and supplies a resulting moving image to the image output section 480 and the recording section 481.

The sound output section 479 includes a speaker and so on. During playback of a moving image, under the control of the CPU 471, the sound output section 479 outputs sound supplied from the recording section 481. The image output section 480 includes a display and so on. During playback of a moving image, under the control of the CPU 471, the image output section 480 displays a moving image supplied from the recording section 481.

The recording section 481 includes a hard disk, a nonvolatile memory, and so on. Under the control of the CPU 471 or the like, the recording section 481 records, during photography of a moving image, sound supplied from the sound input section 477, and supplies, during playback of a moving image, recorded sound to the sound output section 479. Under the control of the CPU 471 or the like, the recording section 481 also records, during photography of a moving image, a moving image supplied from the image input section 478, and supplies, during playback of a moving image, a recorded moving image to the image output section 480.

The PC connection section 482 includes a USB interface and so on and communicates with an external PC (not illustrated).

The video camera 470 configured as described above implements the wakeup processing section 10. A wakeup processing section implemented by the video camera 470 will be described below.

### (Example Configuration of Wakeup Processing Section)

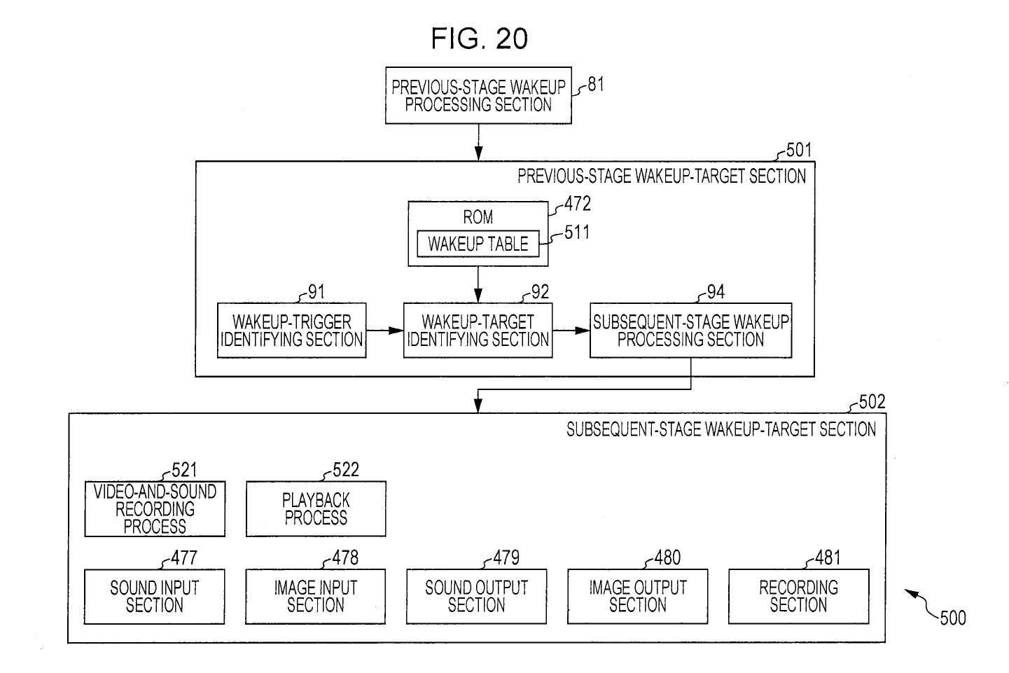

FIG. 20 is a block diagram illustrating an example configuration of a wakeup processing section implemented by the video camera 470 illustrated in FIG. 19.

In the sections illustrated in FIG. 20, sections that are the same as or similar to those illustrated in FIG. 4 are denoted by the same reference numerals. Redundant descriptions are not given as appropriate.

The configuration of a wakeup processing section 500 illustrated in FIG. 20 is different from the configuration illustrated in FIG. 4 in that a previous-stage wakeup-target section 501 and a subsequent-stage wakeup-target section 502 are provided instead of the previous-stage wakeup-target section 82 and the subsequent-stage wakeup-target section 83. The configuration of the previous-stage wakeup-target section 501 is also different from the configuration illustrated in FIG. 4 in that, instead of the wakeup table 93, a wakeup table 511 is stored in the ROM 472.

A previous-stage wakeup processing section 81, a wakeup-trigger identifying section 91, a wakeup-target identifying section 92, and a subsequent-stage wakeup processing section 94 in the wakeup processing section 500 are implemented by, for example, the CPU 471 illustrated in FIG. 19.

In the wakeup table 511, wakeup triggers that can occur in the video camera 470 and processes and devices that are to be woken up during wakeup due to the corresponding wakeup triggers are associated with each other.

The subsequent-stage wakeup-target section 502 implements the subsequent-stage wakeup-target section 13 illustrated in FIG. 1. The subsequent-stage wakeup-target section 502 includes subsequent-stage wakeup elements, such as a video-and-sound recording process 521, a playback process 522, the sound input section 477, the image input section 478, the sound output section 479, the image output section 480, and the recording section 481.

The video-and-sound recording process 521 is a process for performing a moving-image photography operation executed by the CPU 471, and the playback process 522 is a process for performing a moving-image playback operation executed by the CPU 471.

### (Example of Wakeup Table)

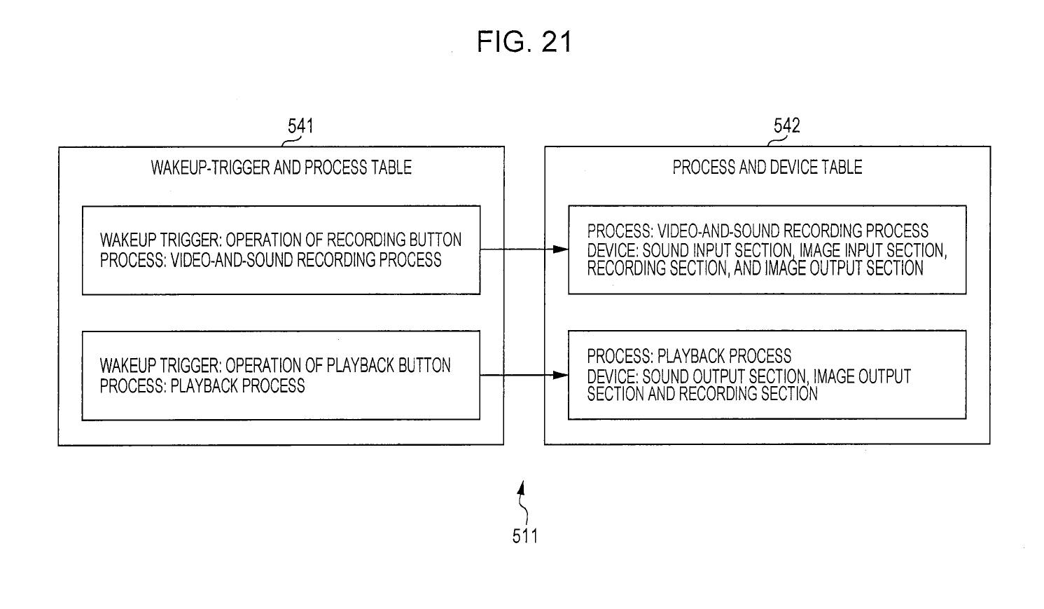

FIG. 21 illustrates an example of the wakeup table 511 illustrated in FIG. 20.

As illustrated in FIG. 21, the wakeup table 511 is constituted by a wakeup-trigger and process table 541 and a process and device table 542, similarly to the wakeup table 93 illustrated in FIG. 5.

In the example illustrated in FIG. 21, in the wakeup-trigger and process table 541, a “video-and-sound recording process” is registered in association with a wakeup trigger “operation of recording button”. A “playback process” is also registered in association with a wakeup trigger “operation of playback button”.

In the example in FIG. 21, in the process and device table 542, devices “sound input section”, “image input section”, “recording section”, and “image output section” are also registered in association with the “video-and-sound recording process”. The devices “sound output section”, “image output section”, and “recording section” are registered in association with the “playback process”.

As described above, in the wakeup table 511 illustrated in FIG. 21, the wakeup trigger “operation of recording button” is associated with the “video-and-sound recording process”, the “sound input section”, the “image input section”, the “recording section”, and the “image output section”. The wakeup trigger “operation of playback button” is also associated with the “playback process”, the “sound output section”, the “image output section”, and the “recording section”.

Since wakeup processing performed by the video camera 470 is analogous to the wakeup processing illustrated in FIG. 6, a description thereof is not given hereinafter.

In the wakeup processing, for example, when the user operates the recording button to generate the wakeup trigger “operation of recording button”, the video-and-sound recording process 521, the sound input section 477, the image input section 478, the recording section 481, and the image output section 480 are woken up. As a result, in accordance with the video-and-sound recording process 521, the CPU 471 causes the sound input section 477 to obtain sound, causes the image input section 478 to photograph a moving image, causes the recording section 481 to record the sound and the moving image, and causes the image output section 480 to display the moving image.

In the wakeup processing, for example, when the user operates the playback button to generate the wakeup trigger “operation of playback button”, the playback process 522, the sound output section 479, the image output section 480, and the recording section 481 are woken up. As a result, in accordance with the playback process 522, the CPU 471 reads a moving image and corresponding sound which are recorded in the recording section 481, causes the sound output section 479 to output the sound, and causes the image output section 480 to display the moving image.

As described above, the video camera 470 identifies wakeup targets in response to a wakeup trigger and wakes up the wakeup targets. Accordingly, similarly to the recording playback apparatus 50, it is possible to reduce the time taken for the wakeup processing, the power consumption during the wakeup processing, the power consumption after the wakeup processing, the time taken for stop processing for already-woken-up devices or processes, the power consumption during the stop processing, and so on.

### Seventh Embodiment

### Example Configuration of Seventh Embodiment of Information Processing Apparatus

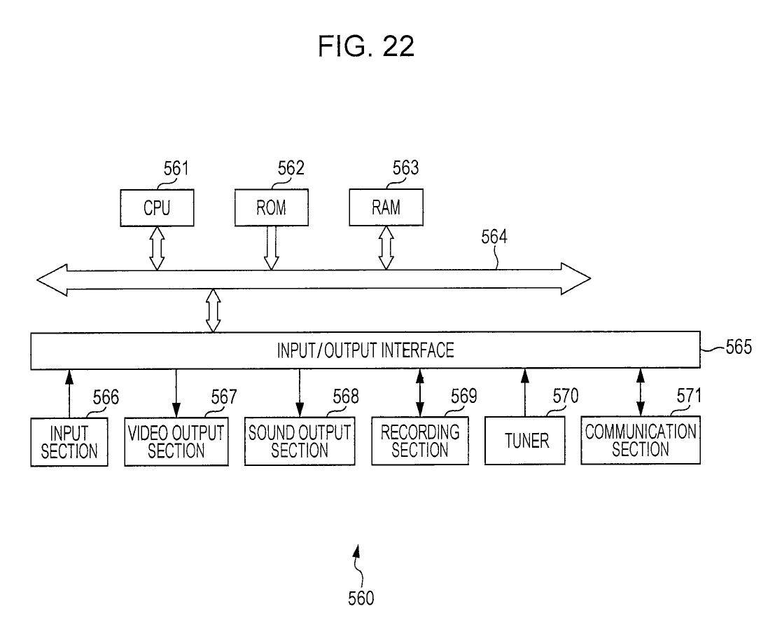

FIG. 22 is a block diagram illustrating an example configuration of a television set according to a seventh embodiment of the information processing apparatus to which the present technology is applied.

A television set 560 illustrated in FIG. 22 performs display of a broadcast program, communication over the Internet, and so on. In the television set 560, a CPU 561, a ROM 562, and a RAM 563 are coupled to each other through a bus 564. An input/output interface 565 is further coupled to the bus 564. An input section 566, a video output section 567, a sound output section 568, a recording section 569, a tuner 570, and a communication section 571 are coupled to the input/output interface 565.

The CPU 561 performs display of a broadcast program, communication over the Internet, and so on, for example, by loading a program recorded in the recording section 569 into the RAM 563 via the input/output interface 565 and the bus 564 and executing the loaded program. During the processing, the CPU 561 refers to information stored in the ROM 562 or writes/reads information to/from the RAM 563, as appropriate.

The input section 566 includes various operation buttons, such as a power button and an Internet button. The power button is a button that a user operates to turn on or off the power of the television set 560, and the Internet button is a button that the user operates to perform communication over the Internet.

The video output section 567 includes a display and so on. During display of a broadcast program, under the control of the CPU 561, the video output section 567 displays video of a broadcast program received by the tuner 570. During communication over the Internet, under the control of the CPU 561, the video output section 567 also displays an image received by the communication section 571.

The sound output section 568 includes a speaker and so on. During display of a broadcast program, under the control of the CPU 561, the sound output section 568 outputs sound of a broadcast program received by the tuner 570. During communication over the Internet, under the control of the CPU 561, the sound output section 568 also outputs sound received by the communication section 571. The recording section 569 includes a hard disk, a nonvolatile memory, and so on.

During display of a broadcast program, under the control of the CPU 561, the tuner 570 obtains video and sound of a predetermined one of broadcast programs, supplies the video to the video output section 567, and also supplies the sound to the sound output section 568.

During communication over the Internet, under the control of the CPU 561, the communication section 571 communicates with an external server (not illustrated) or the like over the Internet to receive an image, sound, and so on. The communication section 571 supplies the received image to the video output section 567 and also supplies the received sound to the sound output section 568.

The television set 560 configured as described above implements the wakeup processing section 10. A wakeup processing section implemented by the television set 560 will be described below.

### (Example Configuration of Wakeup Processing Section)

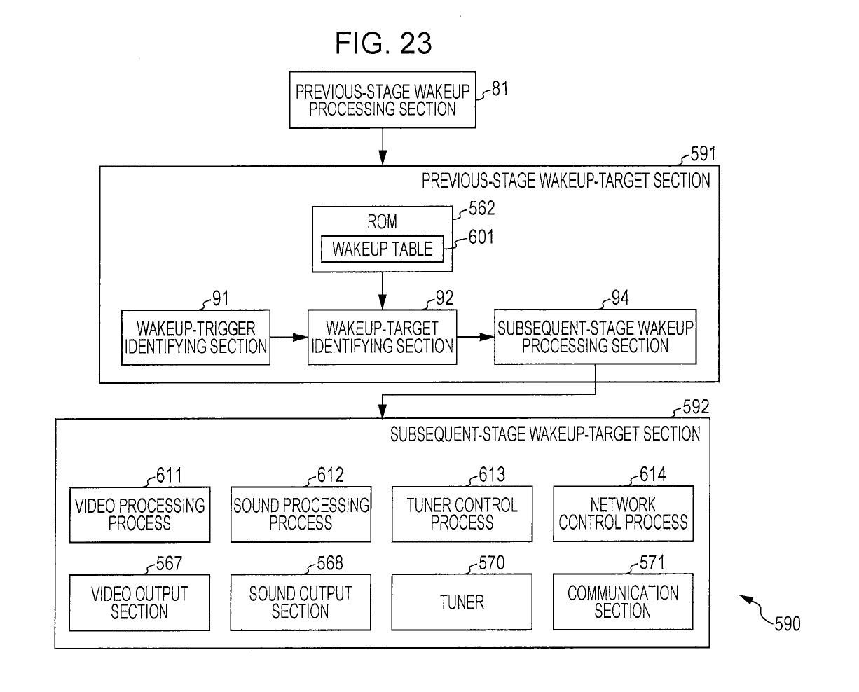

FIG. 23 is a block diagram illustrating an example configuration of a wakeup processing section implemented by the television set 560 illustrated in FIG. 22.

In the sections illustrated in FIG. 23, sections that are the same as or similar to those illustrated in FIG. 4 are denoted by the same reference numerals. Redundant descriptions are not given as appropriate.

The configuration of a wakeup processing section 590 illustrated in FIG. 23 is different from the configuration illustrated in FIG. 4 in that a previous-stage wakeup-target section 591 and a subsequent-stage wakeup-target section 592 are provided instead of the previous-stage wakeup-target section 82 and the subsequent-stage wakeup-target section 83. The configuration of the previous-stage wakeup-target section 591 is also different from the configuration illustrated in FIG. 4 in that, instead of the wakeup table 93, a wakeup table 601 is stored in the ROM 562.

A previous-stage wakeup processing section 81, a wakeup-trigger identifying section 91, a wakeup-target identifying section 92, and a subsequent-stage wakeup processing section 94 in the wakeup processing section 590 are implemented by, for example, the CPU 561 illustrated in FIG. 22.

In the wakeup table 601, wakeup triggers that can occur in the television set 560 and processes and devices that are to be woken up during wakeup due to the corresponding wakeup triggers are associated with each other.

The subsequent-stage wakeup-target section 592 implements the subsequent-stage wakeup-target section 13 illustrated in FIG. 1. The subsequent-stage wakeup-target section 592 includes subsequent-stage wakeup elements, such as a video processing process 611, a sound processing process 612, a tuner control process 613, a network control process 614, the video output section 567, the sound output section 568, the tuner 570, and the communication section 571.

The video processing process 611 is a process for performing a video display operation executed by the CPU 561, and the sound processing process 612 is a process for performing a sound output operation executed by the CPU 561. The tuner control process 613 is also a process for performing a broadcast-program reception operation executed by the CPU 561, and the network control process 614 is a process for performing a communication operation over the Internet, the communication operation being performed by the CPU 561.

### (Example of Wakeup Table)

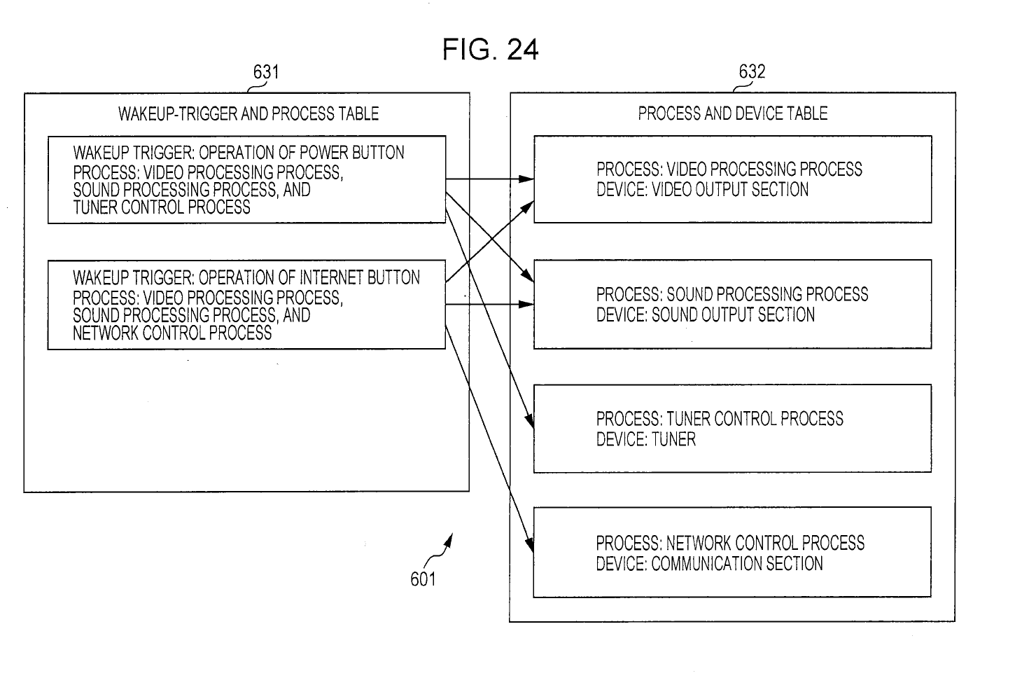

FIG. 24 illustrates an example of the wakeup table 601 illustrated in FIG. 23.

As illustrated in FIG. 24, the wakeup table 601 is constituted by a wakeup-trigger and process table 631 and a process and device table 632, similarly to the wakeup table 93 illustrated in FIG. 5.

In the example illustrated in FIG. 24, in the wakeup-trigger and process table 631, a “video processing process”, a “sound processing process”, and a “tuner control process” are registered in association with a wakeup trigger “operation of power button”. The “video processing process”, the “sound processing process”, and a “network control process” are also registered in association with a wakeup trigger “operation of Internet button”.

In the example illustrated in FIG. 24, in the process and device table 632, a device “video output section” is registered in association with the “video processing process”, and a device “sound output section” is registered in association with the “sound processing process”. A device “tuner” is registered in association with the “tuner control process”, and a device “communication section” is registered in association with the “network control process”.

As described above, in the wakeup table 601 illustrated in FIG. 24, the wakeup trigger “operation of power button” is associated with the “video processing process”, the “sound processing process”, the “tuner control process”, the “video output section”, the “sound output section”, and the “tuner”. The wakeup trigger “operation of Internet button” is also associated with the “video processing process”, the “sound processing process”, the “network control process”, the “video output section”, the “sound output section”, and the “communication section”.

Since wakeup processing performed by the television set 560 is analogous to the wakeup processing illustrated in FIG. 6, a description thereof is not given hereinafter.

In the wakeup processing, for example, when the user operates the power button to generate the wakeup trigger “operation of power button”, the video processing process 611, the sound processing process 612, the tuner control process 613, the video output section 567, the sound output section 568, and the tuner 570 are woken up.

As a result, in accordance with the tuner control process 613, the CPU 561 causes the tuner 570 to receive video and sound of a predetermined broadcast program. In accordance with the video processing process 611, the CPU 561 also causes the video output section 567 to display the broadcast-program video received by the tuner 570. In accordance with the sound processing process 612, the CPU 561 also causes the sound output section 568 to output the broadcast-program sound received by the tuner 570.

In the wakeup processing, for example, when the user operates the Internet button to generate the wakeup trigger “operation of Internet button”, the video processing process 611, the sound processing process 612, the network control process 614, the video output section 567, the sound output section 568, and the communication section 571 are woken up.

As a result, in accordance with the network control process 614, the CPU 561 causes the communication section 571 to perform communication over the Internet. In accordance with the video processing process 611, the CPU 561 causes the video output section 567 to display images received by the communication section 571. In accordance with the sound processing process 612, the CPU 561 also causes the sound output section 568 to output sound received by the communication section 571.

As described above, the television set 560 identifies wakeup targets in response to a wakeup trigger and wakes up the wakeup targets. Accordingly, similarly to the recording playback apparatus 50, it is possible to reduce the time taken for the wakeup processing, the power consumption during the wakeup processing, the power consumption after the wakeup processing, the time taken for stop processing for already-woken-up devices or processes, the power consumption during the stop processing, and so on.

Although a case in the present technology is applied to the wakeup processing performed when a wakeup trigger occurs and the state transitions from the sleep state to the operating state has been described in the first to seventh embodiments, the present technology may also be applied to wakeup processing that is additionally performed when a wakeup trigger occurs in the operating state (hereinafter referred to as “additional wakeup processing”). Needless to say, the present technology may also be applied to both the wakeup processing and the additional wakeup processing.

A description will be given below of the additional wakeup processing section that performs additional wakeup processing during electronic-mail reception realized by the mobile phone 130 in FIG. 7 when the present technology is applied to the additional wakeup processing performed by the mobile phone 130.

### Eighth Embodiment

### Example Configuration of Additional Wakeup Processing Section

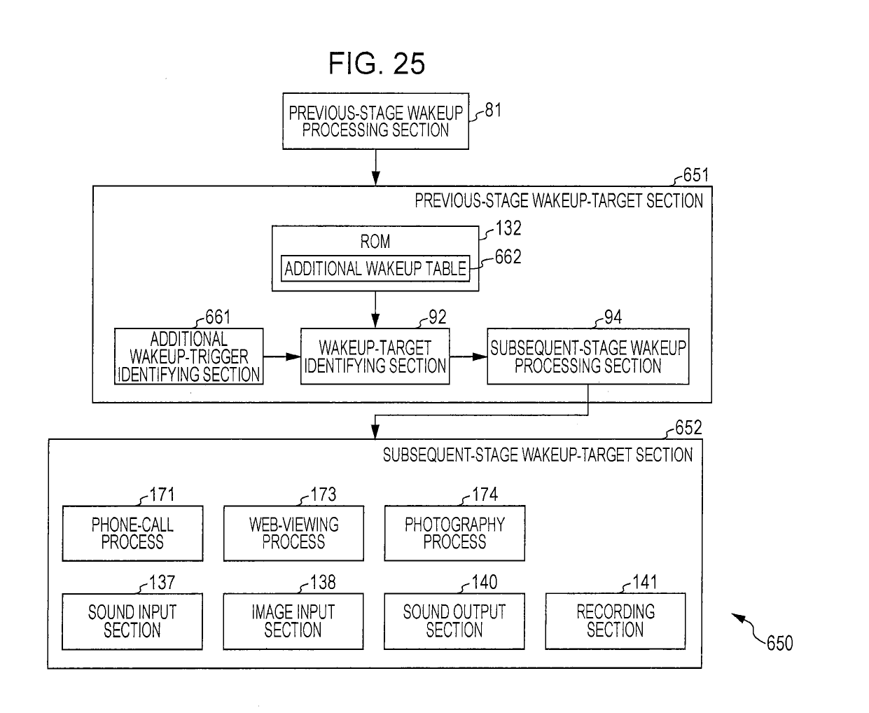

FIG. 25 is a block diagram illustrating an example configuration of an additional wakeup processing section that performs additional wakeup processing during electronic-mail reception implemented by the mobile phone 130 illustrated in FIG. 7.

In the sections illustrated in FIG. 25, sections that are the same as or similar to those illustrated in FIG. 8 are denoted by the same reference numerals. Redundant descriptions are not given as appropriate.

The configuration of an additional wakeup processing section 650 illustrated in FIG. 25 is different from the configuration of the wakeup processing section 150 illustrated in FIG. 8 in that a previous-stage wakeup-target section 651 and a subsequent-stage wakeup-target section 652 are provided instead of the previous-stage wakeup-target section 151 and the subsequent-stage wakeup-target section 152. The configuration of the previous-stage wakeup-target section 651 is also different from the configuration illustrated in FIG. 8 in that an additional wakeup-trigger identifying section 661 is provided instead of the wakeup-trigger identifying section 91 and an additional wakeup table 662 is provided instead of the wakeup table 161.

The additional wakeup-trigger identifying section 661 implements the wakeup-trigger identifying section 21 illustrated in FIG. 1, for example, through use of the CPU 131 illustrated in FIG. 7. The additional wakeup-trigger identifying section 661 identifies a wakeup trigger that occurs during electronic-mail reception and supplies information indicating the identified wakeup trigger to a wakeup-target identifying section 92.

The additional wakeup table 662 corresponds to the wakeup table 23 illustrated in FIG. 1 and is a table in which a wakeup trigger that occurs during electronic-mail reception and a subsequent-stage wakeup element to be newly woken up in response to the wakeup trigger are associated with each other.

The subsequent-stage wakeup-target section 652 implements the subsequent-stage wakeup-target section 13 illustrated in FIG. 1. The subsequent-stage wakeup-target section 652 includes subsequent-stage wakeup elements, such as a phone-call process 171, a web-viewing process 173, a photography process 174, a sound input section 137, an image input section 138, a sound output section 140, and a recording section 141.

Thus, since the additional wakeup processing section 650 performs additional wakeup processing in response to a wakeup trigger that occurs during electronic-mail reception, the mail process 172 and the image output section 139 that have already been woken up during the electronic-mail reception are not included in the subsequent-stage wakeup-target section 652.

### (Example of Wakeup Table)

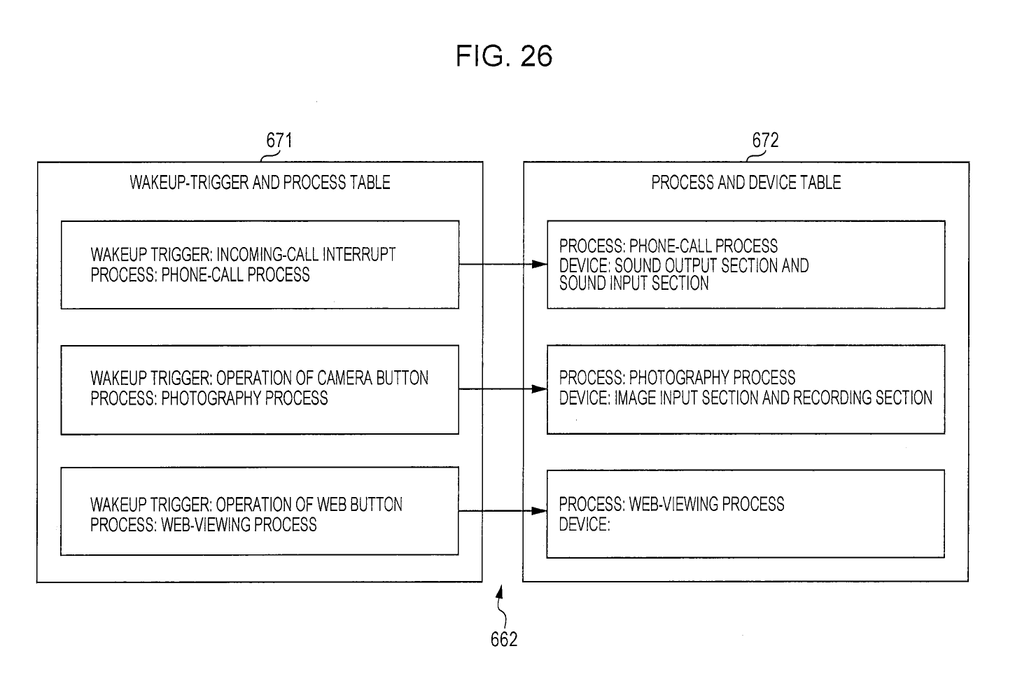

FIG. 26 illustrates an example of the additional wakeup table illustrated in FIG. 25.

As illustrated in FIG. 26, the additional wakeup table 662 is constituted by a wakeup-trigger and process table 671 and a process and device table 672. The additional wakeup table 662 is different from the wakeup table 161 in FIG. 9 in that a wakeup trigger “electronic-mail reception interrupt” that has already occurred and a “mail process” and an “image output section” that have already woken are not registered in association with the wakeup trigger.

More specifically, the wakeup-trigger and process table 671 is a table in which a wakeup trigger that occurs during electronic-mail reception and a process to be newly woken up in response to the wakeup trigger are associated with each other. In the wakeup-trigger and process table 671, a “phone-call process” is registered in association with a wakeup trigger “incoming-call interrupt”, and a “photography process” is registered in association with a wakeup trigger “operation of camera button”. A “web-viewing process” is also registered in association with a wakeup trigger “operation of web button”.

The process and device table 672 is a table in which processes and devices that are to be newly woken up during execution of the processes are associated with each other. In the process and device table 672, devices “sound output section” and “sound input section” are registered in association with the “phone-call process”, and devices “image input section” and “recording section” are registered in association with the “photography process”. No device is registered in association with the “web-viewing process”.

As described above, in the additional wakeup table 662 in FIG. 26, the wakeup trigger “incoming-call interrupt” is associated with the “phone-call process”, the “sound output section”, and the “sound input section”. The wakeup trigger “operation of camera button” is associated with the “photography process”, the “image input section”, and the “recording section”, and the wakeup trigger “operation of web button” is associated with the “web-viewing process”.

Since additional wakeup processing performed by the mobile phone 130 is analogous to the wakeup processing illustrated in FIG. 6, a description thereof is not given hereinafter.

In the additional wakeup processing, for example, when an incoming call is received during electronic-mail reception to cause an incoming phone-call interrupt, the phone-call process 171, the sound output section 140, and the sound input section 137 are woken up, and the state of the mobile phone 130 transitions to a state in which a phone-call operation can be performed.

As a result, in accordance with the phone-call process 171, the CPU 131 causes the image output section 139 to display an image indicating incoming-call information and causes the sound output section 140 to output voice of the phone call received by the communication section 142. In accordance with the phone-call process 171, the CPU 131 also transmits signals of phone-call voice obtained by the sound input section 137 to the communication section 142. After the phone call is finished, the mobile phone 130 stops the phone-call process 171, the sound output section 140, and the sound input section 137, and the state transitions to a state in which the previous communication operation is disabled.

In the additional wakeup processing, for example, when the user operates the camera button of the input section 136 during electronic-mail reception to generate the wakeup trigger “operation of camera button”, the photography process 174, the image input section 138, and the recording section 141 are woken up. As a result, in accordance with the photography process 174, the CPU 131 causes the image input section 138 to perform photography, causes the image output section 139 to display a resulting image as a live-view image, and causes the recording section 141 to record the image.

In the additional wakeup processing, for example, when the user operates the web button of the input section 136 during electronic-mail reception to generate the wakeup trigger “operation of web button”, the web-viewing process 173 is woken up. As a result, in accordance with the web-viewing process 173, the CPU 131 causes the communication section 142 to receive a web page and causes the image output section 139 to display an image of the received web page.

As described above, a subsequent-stage wakeup processing section 94 identifies a wakeup target in response to a wakeup trigger that occurs during electronic-mail reception and additionally wakes up the wakeup target. Thus, it is possible to wake up only a device and a process that have not been woken up yet and that are to be woken up in response to the generated wakeup trigger. That is, it is possible to ensure that a device and a process that are not to be woken up are not additionally woken up. Thus, it is possible to reduce the time taken for the additional wakeup processing, and it is possible to reduce the power consumption during the additional wakeup processing. It is also possible to reduce the power consumption after the additional wakeup processing, and it is also possible to reduce the time taken for processing for stopping a device and a process already woken up by the additional wakeup processing and the power consumption during the stop processing.

Although the additional wakeup processing during electronic-mail reception has been described above by way of example, the same also applies to additional wakeup processing in an operating state other than the electronic-mail reception.

In addition, although the additional wakeup processing has been performed using the additional wakeup table 662 that is different from the wakeup table 161, the additional wakeup processing may also be performed using the wakeup table 161. In such a case, of the processes and devices in the wakeup table 161 which are associated with a generated wakeup trigger, only a process and a device that have not been woken up are woken up.

A case in which the wakeup table is stored in the ROM has been described above, the storage location of the wakeup table is not limited to the ROM. The wakeup table may also be stored in the RAM or the recording section.

As a method for creating the above-described wakeup table, there are, for example, three methods described below. A first method is a method for manually creating the wakeup table during design of the information processing apparatus. The first method is used, for example, when the operation modes of the information processing apparatus have been determined in advance and thus associations between wakeup triggers and processes and associations between the processes and devices can be easily identified.

A second method is a method for automatically creating the wakeup table during design of the information processing apparatus. In the second method, the information processing apparatus is woken up in response to each wakeup trigger, and after the wakeup, a process and a device to be operated are detected. The individual wakeup trigger and the detected process and device are registered in the wakeup table in association with each other.

A third method is a method for automatically creating the wakeup table during operation of the information processing apparatus. In the third method, all processes and devices are woken up during initial wakeup, and a wakeup trigger at this time and a process and a device that are operated after the wakeup are detected. The wakeup trigger and the detected process and device are registered in the wakeup table in association with each other. During next wakeup, the wakeup table is referred to. At this point, when a current wakeup trigger has not been registered in the wakeup table, all of the processes and devices are woken up and registration in the wakeup table is performed as in the case of the initial wakeup. On the other hand, when the current wakeup trigger has been registered in the wakeup table, only a process and a device corresponding to the wakeup trigger are woken up. The information processing apparatus learns the wakeup table while operating in the same manner as described above.

The above-described program executed by the CPU may be supplied through wired or wireless transmission media, such as a local area network, the Internet, and digital satellite broadcast. The program may also be received by the communication section or the PC connection section through a wired or wireless transmission medium and be installed to the recording section. Additionally, the program may be pre-installed in the ROM or the recording section.

The program may be a program that time-sequentially performs processing according to the sequence described hereinabove, may be a program that performs processing in parallel, or may be a program that performs processing at an arbitrary timing, for example, at the time when the program is called.

The embodiments of the present technology are not limited to the above-described embodiments, and various changes and modifications can be made thereto without departing from the spirit and scope of the present technology.

The present technology may also employ a configuration as described below.

(1) An information processing apparatus including:

a wakeup-target identifying section configured to identify a wakeup target in response to a wakeup trigger; and

a wakeup processing section configured to wake up the wakeup target identified by the wakeup-target identifying section.

(2) The information processing apparatus according to (1), wherein the wakeup-target identifying section identifies the wakeup target by referring to a table in which the wakeup trigger and the wakeup target are associated with each other.

(3) The information processing apparatus according to (1), wherein the wakeup target includes a process or a device.

(4) The information processing apparatus according to (3), wherein the wakeup-target identifying section identifies the wakeup target by referring to a table in which the wakeup trigger and the process are associated with each other and the process and the device are associated with each other.

(5) The information processing apparatus according to one of (1) to (4), wherein the wakeup trigger occurs in a sleep state.

(6) The information processing apparatus according to one of (1) to (5), wherein the wakeup trigger occurs in an operating state.

(7) An information processing method including:

identifying, by an information processing apparatus, a wakeup target in response to a wakeup trigger; and

waking up, by the information processing apparatus, the identified wakeup target.

(8) A program for causing a computer to function as:

a wakeup-target identifying section that identifies a wakeup target in response to a wakeup trigger; and

a wakeup processing section that wakes up the wakeup target identified by the wakeup-target identifying section.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a wakeup-target identifying section configured to identify a wakeup target in response to a wakeup trigger; and
a wakeup processing section configured to wake up the wakeup target identified by the wakeup-target identifying section.

2. The information processing apparatus according to claim 1, wherein the wakeup-target identifying section identifies the wakeup target by referring to a table in which the wakeup trigger and the wakeup target are associated with each other.

3. The information processing apparatus according to claim 1, wherein the wakeup target comprises a process or a device.

4. The information processing apparatus according to claim 3, wherein the wakeup-target identifying section identifies the wakeup target by referring to a table in which the wakeup trigger and the process are associated with each other and the process and the device are associated with each other.

5. The information processing apparatus according to claim 1, wherein the wakeup trigger occurs in a sleep state.

6. The information processing apparatus according to claim 1, wherein the wakeup trigger occurs in an operating state.

7. An information processing method comprising:
identifying, by an information processing apparatus, a wakeup target in response to a wakeup trigger; and
waking up, by the information processing apparatus, the identified wakeup target.

8. A program for causing a computer to function as:
a wakeup-target identifying section that identifies a wakeup target in response to a wakeup trigger; and
a wakeup processing section that wakes up the wakeup target identified by the wakeup-target identifying section.
